(19) United States
(12) Patent Application Publication
(10) Pub. No.: US 2024/0385419 A1
(43) Pub. Date: Nov. 21, 2024

(54) ZOOM LENS AND IMAGE PICKUP APPARATUS

(71) Applicant: CANON KABUSHIKI KAISHA, Tokyo (JP)

(72) Inventors: Naotoshi OGAWA, Tochigi (JP); Yutaka IRIYAMA, Saitama (JP); Yusuke KUROSU, Tochigi (JP)

(21) Appl. No.: 18/645,474

(22) Filed: Apr. 25, 2024

(30) Foreign Application Priority Data
May 15, 2023 (JP) 2023-080331

(51) Int. Cl. G02B 15/167; G02B 13/02; H04N 23/55

(52) U.S. Cl. CPC G02B 15/167; G02B 13/02; H04N 23/55

(57) ABSTRACT

A zoom lens includes, in order from an object side to an image side, a first lens unit having positive refractive power and fixed for zooming, an intermediate group including three or more lens units that move for zooming, a rear lens unit having positive refractive power and fixed for zooming. The intermediate group includes a first negative lens unit having negative refractive power as a whole and including a single lens unit or two or more partial lens units configured to monotonically move toward the image side during zooming from a wide-angle end to a telephoto end, a positive lens unit having positive refractive power, disposed closest to an image plane, and configured to move during zooming, and a second negative lens unit having negative refractive power, disposed on the object side of the positive lens, and configured to move during zooming. Predetermined inequalities are satisfied.

### BACKGROUND

### Technical Field

One of the aspects of the embodiments relates to a zoom lens for image pickup apparatus.

### Description of Related Art

Zoom lenses for image pickup apparatuses such as television cameras, movie cameras, digital still cameras, and video cameras are demanded to have a reduced size and weight, a wide angle of view, a high zoom ratio, and high optical performance. Along with the use of image sensors compatible with high resolutions such as 4K and 8K, they are further demanded to form an optical image with high resolving power and little chromatic aberration from the central portion to the peripheral portion.

Known as a zoom lens having a wide angle of view and a high zoom ratio is a positive lead type zoom lens that includes, in order from the object side to the image side, a first lens unit having positive refractive power, and a second lens unit having negative refractive power that moves for zooming. Japanese Patent Laid-Open Nos. 2014-215586 and 2019-39945 disclose zoom lenses each including, in order from the object side to the image side, a first lens unit having positive refractive power that is fixed (does not move) for zooming, a plurality of lens units that move for zooming, and a rear lens unit having positive refractive power that is fixed for zooming.

The zoom lenses disclosed in Japanese Patent Laid-Open Nos. 2014-215586 and 2019-39945 have a half angle of view of about 35° at a wide-angle end and a zoom ratio of about 20 time. However, for a wider angle of view and a higher zoom ratio of the zoom lens, a large size of the first lens unit and a large moving amount of the second lens unit may not be beneficial to the high optical performance and reduced size.

### SUMMARY

A zoom lens according to one aspect of the disclosure includes, in order from an object side to an image side, a first lens unit having positive refractive power and fixed for zooming, an intermediate group including three or more lens units that move for zooming, a rear lens unit having positive refractive power and fixed for zooming. A distance between adjacent lens units changes during zooming. The intermediate group includes a first negative lens unit having negative refractive power as a whole and including a single lens unit or two or more partial lens units configured to monotonically move toward the image side during zooming from a wide-angle end to a telephoto end, a positive lens unit having positive refractive power, disposed closest to an image plane, and configured to move during zooming, and a second negative lens unit having negative refractive power, disposed on the object side of the positive lens, and configured to move during zooming. The following inequalities are satisfied:

$$\begin{matrix}1. & \leq f 1 / fR & \leq 2. \\ - 5. & \leq β Pw & \leq - 1.\end{matrix}$$

where f1 is a focal length of the first lens unit, fR is a focal length of the rear lens unit, and βPw is a lateral magnification of the positive lens unit at the wide-angle end. An image pickup apparatus having the above zoom lens also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of a zoom lens according to Example 1.

FIGS. 2A, 2B, 2C, and 2D are aberration diagrams of the zoom lens according to Example 1.

FIG. 3 is a sectional view of a zoom lens according to Example 2.

FIGS. 4A, 4B, 4C, and 4D are aberration diagrams of the zoom lens according to Example 2.

FIG. 5 is a sectional view of a zoom lens according to Example 3.

FIGS. 6A, 6B, 6C, and 6D are aberration diagrams of the zoom lens according to Example 3.

FIG. 7 is a sectional view of a zoom lens according to Example 4.

FIGS. 8A, 8B, 8C, and 8D are aberration diagrams of the zoom lens according to Example 4.

FIG. 9 is a sectional view of a zoom lens according to Example 5.

FIGS. 10A, 10B, 10C, and 10D are aberration diagrams of the zoom lens according to Example 5.

FIG. 11 is a sectional view of a zoom lens according to Example 6.

FIGS. 12A, 12B, 12C, and 12D are aberration diagrams of the zoom lens according to Example 6.

FIG. 13 illustrates the configuration of an image pickup apparatus.

### DESCRIPTION OF THE EMBODIMENTS

Referring now to the accompanying drawings, a detailed description will be given of embodiments according to the disclosure.

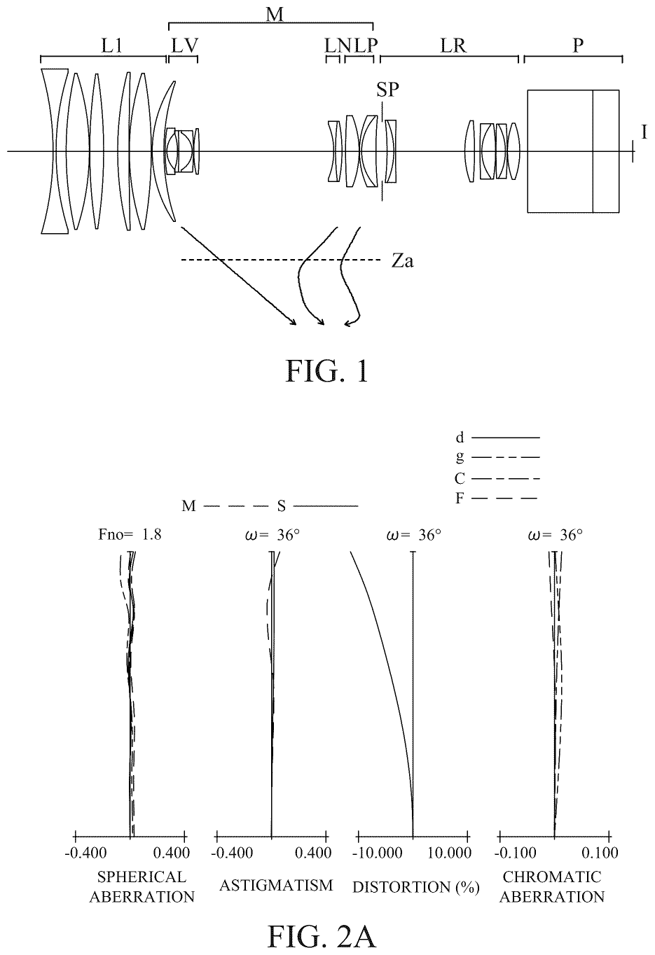

Prior to a specific description according to Examples 1 to 6, a description will be given of common matters to each example using FIG. 1 illustrating a zoom lens according to Example 1. FIG. 1 illustrates the configuration of the zoom lens according to Example 1 at the wide-angle end in an in-focus state at infinity.

In a zoom lens, a lens unit is a group of one or more lenses that move together during zooming (magnification variation) between a wide-angle end and a telephoto end. That is, a distance between adjacent lens units changes during zooming. The lens unit may include an aperture stop (diaphragm). The wide-angle end and telephoto end are zoom states at the maximum angle of view (shortest focal length) and the minimum angle of view (maximum focal length), respectively, when the lens unit that moves during zooming is located at both ends of a mechanically or controllably movable range on the optical axis.

The zoom lens according to each example includes, in order from the object side to the image side, a first lens unit L1, an intermediate group M including three or more lens units, an aperture stop SP, and a rear lens unit (relay lens unit) LR.

The first lens unit L1 is fixed (does not move) for zooming and has positive refractive power.

The intermediate group M includes a first negative lens unit LV having negative refractive power. The intermediate group M further includes a positive lens unit LP having positive refractive power closest to the image plane. The intermediate group M further includes a negative lens unit a second negative lens unit LN having negative refractive power. The first negative lens unit LV monotonically moves toward the image side during zooming from the wide-angle end to the telephoto end. The second negative lens unit LN non-monotonically moves so as to draw a convex locus toward the object side during zooming. During zooming from the wide-angle end to the telephoto end, the positive lens unit LP non-monotonically moves so as to draw a convex locus toward the object side, and then moves to draw a convex locus toward the image side. The intermediate group M may include another lens unit. The first negative lens unit LV may include a single lens unit or two or more partial lens units (see Example 2).

The aperture stop SP is fixed (does not move) during zooming. The rear lens unit LR is fixed for zooming and has positive refractive power.

I represents an image plane. Disposed on the image plane I is an imaging surface (light receiving surface) of an image sensor or a film surface (photosensitive surface) of a silver film.

A glass block P such as a prism or an optical filter is disposed between the zoom lens and the image plane I. The glass block P may not be provided.

For focusing from a long-distance object to a short-distance object, the whole or part of the first lens unit L1 moves.

The zoom lens according to each example (each numerical example described later) satisfies the following inequalities:

$$\begin{matrix}1. & \leq f 1 / fR & \leq 2.\end{matrix} \qquad ( 1 )$$

$$\begin{matrix}- 5. & \leq β Pw & \leq - 1.\end{matrix} \qquad ( 2 )$$

where f1 is a focal length of the first lens unit L1, fR is a focal length of the rear lens unit LR, and βPw is a lateral magnification of the positive lens unit LP included in the intermediate group M at the wide-angle end.

The second negative lens unit LN and positive lens unit LP move toward the object side during zooming from the wide-angle end to the zoom position Za. The first negative lens unit LV is closer to the object at the same zoom position Za, and thereby the entrance pupil position of the zoom lens can be closer to the object. This configuration can prevent the first lens unit L1 from becoming excessively large. The zoom position Za is a position having a zoom magnification Z^{0.25} where Z is a zoom magnification from the wide-angle end to the telephoto end.

Inequality (1) defines a condition for obtaining a zoom lens that is beneficial to a wide angle of view, a high zoom ratio, a small size and light weight, and high optical performance. In a case where f1/fR becomes higher than the upper limit of inequality (1), the focal length of the first lens unit L1 becomes too long, and the lateral magnification of the first negative lens unit LV at the wide-angle end becomes too small. As a result, the moving amount of the first negative lens unit LV increases during zooming from the wide-angle end to the telephoto end, and the entrance pupil of the zoom lens is located excessively on the image side at the wide-angle end. Therefore, the diameter of the first lens unit L1 and the size of the zoom lens increase. In a case where f1/fR becomes lower than the lower limit of inequality (1), the focal length of the first lens unit L1 becomes too short, and the magnification of the first lens unit L1 at the telephoto end becomes large. As a result, various aberrations at the telephoto end increase.

Inequality (2) defines a condition for obtaining a zoom lens that is beneficial to a wide angle of view, a high zoom ratio, a small size and light weight, and high optical performance. In a case where βPw becomes higher than the upper limit of inequality (2), the moving amount of the positive lens unit LP becomes too large in image point correction on the telephoto side. As a result, the space required for the movement of the positive lens unit LP during zooming increases, and the size of the zoom lens increases. In a case where βPw becomes lower than the lower limit of inequality (2), magnification changes associated with movement of the positive lens unit LP during zooming from the wide-angle end to the zoom position Za becomes too small. As a result, the entrance pupil of the zoom lens is located excessively on the image side at the wide-angle end, and the diameter of the first lens unit L1 and the size of the zoom lens increase.

The zoom lens according to each example may satisfy at least one of the following inequalities (3) to (14).

The zoom lens according to each example may satisfy the following inequality:

$$1.01 \leq β Pt / β Pw \leq 1.2 \qquad ( 3 )$$

where βPw is a lateral magnification of the positive lens unit LP included in the intermediate group M at the wide-angle end, and βPt is a lateral magnification of the positive lens unit LP at the telephoto end.

Inequality (3) defines a condition for obtaining a zoom lens that is beneficial to a wide angle of view, a a high zoom ratio, a small size and light weight, and high optical performance. In a case where βPt/βPw becomes higher than the upper limit of inequality (3), a moving amount of the positive lens unit LP becomes too large during zooming from the wide-angle end to the telephoto end, and the size of the zoom lens increases. In a case where βPt/βPw becomes lower than the lower limit of inequality (3), a zoom ratio of the first negative lens unit LV becomes too large during zooming from the wide-angle end to the telephoto end, and a moving amount of the first negative lens unit LV becomes large or a lateral magnification of the first negative lens unit LV becomes too large and the diameter of the first lens unit L1 required at the wide-angle end increases. As a result, the size of the zoom lens increases.

Each zoom lens according to this example may satisfy the following inequality:

$$0.3 \leq fP / fR \leq 1. \qquad ( 4 )$$

where fR is a focal length of the rear lens unit LR, and fP is a focal length of the positive lens unit LP included in the intermediate group M.

Inequality (4) defines a condition for obtaining a zoom lens that is beneficial to a wide angle of view, a high zoom ratio, a small size and light weight, and high optical performance. In a case where fP/fR becomes higher than the upper limit of inequality (4), the refractive power of the positive lens unit LP becomes too weak and the size of the zoom lens increases. In a case where fP/fR becomes lower than the lower limit of inequality (4), the refractive power of the positive lens unit LP becomes too strong and fluctuations in various aberrations during zooming become significant.

Each zoom lens according to this example may satisfy the following inequality:

$$- 3. \leq fN / fR \leq - 0.5 \qquad ( 5 )$$

where fR is a focal length of the rear lens unit LR, and fN is a focal length of the second negative lens unit LN included in the intermediate group M.

Inequality (5) defines a condition for obtaining a zoom lens that is beneficial to a wide angle of view, a high zoom ratio, a small size and light weight, and high optical performance. In a case where fN/fR becomes higher than the upper limit of inequality (5), the refractive power of the second negative lens unit LN becomes too weak and the size of the zoom lens increases. In a case where fN/fR becomes lower than the lower limit of inequality (5), the refractive power of the second negative lens unit LN becomes too strong and fluctuations in various aberrations during zooming increases.

Each zoom lens according to this example may satisfy the following inequality:

$$- 1. \leq fP / fN \leq - 0.2 \qquad ( 6 )$$

where fP is a focal length of the positive lens unit LP included in the intermediate group M, and fN is a focal length of the second negative lens unit LN.

Inequality (6) defines a relationship between the focal lengths of the positive lens unit LP and the second negative lens unit LN. Satisfying inequality (6) can provide an effect that the moving amounts of the positive lens unit LP and the second negative lens unit LN during zooming do not become too large, or that the fluctuations of various aberrations do not become too large.

Each zoom lens according to this example may satisfy the following inequality:

$$- 4. \leq fP / fV \leq - 1.5 \qquad ( 7 )$$

where fV is a focal length at the wide-angle end of the first negative lens unit LV included in the intermediate group M, and fP is a focal length of the positive lens unit LP.

The relationship between the focal lengths of the first negative lens unit LV and the positive lens unit LP is defined. Satisfying inequality (7) can provide an effect that the moving amounts of the first negative lens unit LV and positive lens unit LP during zooming do not become too large or that fluctuations in various aberrations do not become too large.

Each zoom lens according to this example may satisfy the following inequality:

$$2. \leq fN / fV \leq 10. \qquad ( 8 )$$

where fV is a focal length of the first negative lens unit LV included in the intermediate group M at the wide-angle end, and fN is a focal length of the second negative lens unit LN.

Inequality (8) defines a relationship between the focal lengths of the first negative lens unit LV and the second negative lens unit LN. Satisfying inequality (8) can provide an effect that the moving amounts of the first negative lens unit LV and the second negative lens unit LN during zooming do not become too large, or the fluctuations of various aberrations do not become too large.

Each zoom lens according to this example may satisfy the following inequality:

$$0.2 \leq β Nw \leq 0.8 \qquad ( 9 )$$

where βNw is a lateral magnification of the second negative lens unit LN included in the intermediate group M at the wide-angle end.

Inequality (9) defines a condition for obtaining a zoom lens that is beneficial to a wide angle of view, a high zoom ratio, a small size and light weight, and high optical performance. In a case where βNw becomes higher than the upper limit of inequality (9), the moving amount of the second negative lens unit LN during image point correction on the telephoto side becomes too large, the space necessary for the movement of the second negative lens unit LN during zooming becomes larger, and the size of the zoom lens increases. In a case where βNw becomes lower than the lower limit of inequality (9), the magnification changes caused by the movement of the first negative lens unit LV during zooming from the wide-angle end to the zoom position Za become too small, and the entrance pupil of the zoom lens becomes too close to the image plane at the wide-angle end. As a result, the diameter of the first lens unit L1 increases and the size of the zoom lens increases.

Each zoom lens according to this example may satisfy the following inequality:

$$- 0.35 \leq β Vw \leq - 0.15 \qquad ( 10 )$$

where βVw is a lateral magnification of the first negative lens unit LV included in the intermediate group M at the wide-angle end.

Inequality (10) defines a condition for obtaining a zoom lens that is beneficial to a wide angle of view, a high zoom ratio, a small size and light weight, and high optical performance. In a case where βVw becomes higher than the upper limit of inequality (10), the moving amount of the first negative lens unit LV during zooming becomes too large, the space necessary for the movement of the first negative lens unit LV becomes large, and the size of the zoom lens increases. In a case where βVw becomes lower than the lower limit of inequality (10), the change in the image point position of the first negative lens unit LV on the telephoto side becomes too large, and the moving amounts of the second negative lens unit LN and positive lens unit LP becomes large. As a result, the size of the zoom lens increases and fluctuations in various aberrations during zooming become too large.

Each zoom lens according to this example may satisfy the following inequality:

$$1.6 \leq NdPp \leq 1.9 \qquad ( 11 )$$

where NdPp is an average value of the refractive index for the d-line of one or more positive lenses included in the positive lens unit LP of the intermediate group M.

Inequality (11) defines a condition for obtaining a zoom lens that is beneficial to a wide angle of view, a high zoom ratio, a small size and light weight, and high optical performance. In a case where NdPp becomes lower than the lower limit of inequality (11), fluctuations in various aberrations during zooming become too large. In a case where NdPp becomes higher than the upper limit of inequality (11), the dispersion of the material increases, and the fluctuation of chromatic aberration during zooming becomes too large.

Each zoom lens according to this example may satisfy the following inequality:

$$16. \leq vdPn \leq 30. \qquad ( 12 )$$

where vdPn is an average value of the Abbe numbers based on the d-line of one or more negative lenses included in the positive lens unit LP of the intermediate group M.

The Abbe number based on the d-line of a certain material is represented as follows:

$$vd = ( Nd - 1 ) / ( NF - NC )$$

where Nd, NF, and NC are refractive indexes of the d-line (587.6 nm), F-line (486.1 nm), and C-line (656.3 nm) in the Fraunhofer line.

Inequality (12) defines a condition for obtaining a zoom lens that is beneficial to a wide angle of view, a high zoom ratio, a small size and light weight, and high optical performance. In a case where vdPn becomes higher than the upper limit of inequality (12), the variation in chromatic aberration during zooming becomes too large. In addition, the curvature of the negative lens in the positive lens unit LP becomes too small, the volume of the negative lens becomes large, and the size of the positive lens unit LP increases. As a result, the size of a mechanism for moving the positive lens unit LP during zooming increases. In a case where vdPn becomes lower than the lower limit of inequality (12), it becomes difficult to obtain an optical material for a negative lens that transmits visible light.

Each zoom lens according to this example may satisfy the following inequality:

$$1.2 \leq β Pz / β Pw \times β Nz / β Nw \leq 1.6 \qquad ( 13 )$$

where βPw is a lateral magnification of the positive lens unit LP included in the intermediate group M at the wide-angle end, and βNw is a lateral magnification of the second negative lens unit LN at the wide-angle end, βPz is a lateral magnification of the positive lens unit LP at a zoom position Za, and βNz is a lateral magnification of the second negative lens unit LN at the zoom position Za.

Inequality (13) defines a condition for obtaining a zoom lens that is beneficial to a wide angle of view, a high zoom ratio, a small size and light weight, and high optical performance. In a case where the value of inequality (13) becomes higher than the upper limit, the second negative lens unit LN and positive lens unit LP at the zoom position Za are located too close to the object, and various aberrations at the zoom position Za become too large. In a case where the value of inequality (13) becomes lower than the lower limit, the entrance pupil of the zoom lens will be located too much on the image side, and the first lens unit L1 becomes larger.

Each zoom lens according to this example may satisfy the following inequality:

$$0.9 \leq fPG 1 / fP \leq 1.8 \qquad ( 14 )$$

where fPG1 is a focal length of the positive lens G1 disposed closest to the object among the positive lens unit LP included in the intermediate group M, and fP is a focal length of the positive lens unit LP.

Inequality (14) defines a condition for obtaining a zoom lens that is beneficial to a wide angle of view, high zoom ratio, small size and light weight, and high optical performance. In a case where fPG1/fP does not satisfy inequality (14), fluctuations in various aberrations during zooming becomes too large.

Inequalities (1) to (14) may be replaced with the following inequalities (1a) to (14a):

$$1.1 \leq f 1 / fR \leq 1.9 \qquad ( 1 a )$$

$$- 4.5 \leq β Pw \leq - 1.8 \qquad ( 2 a )$$

$$1.03 \leq β Pt / β Pw \leq 1.15 \qquad ( 3 a )$$

$$0.5 \leq fP / fR \leq 0.9 \qquad ( 4 a )$$

$$- 2. \leq fN / fR \leq - 1. \qquad ( 5 a )$$

$$- 0.8 \leq fP / fN \leq - 0.3 \qquad ( 6 a )$$

$$- 3. \leq fP / fV \leq - 2. \qquad ( 7 a )$$

$$3. \leq fN / fV \leq 8. \qquad ( 8 a )$$

$$0.3 \leq β Nw \leq 0.55 \qquad ( 9 a )$$

$$- 0.3 \leq β Nw \leq - 0.2 \qquad ( 10 a )$$

$$1.65 \leq NdPp \leq 1.85 \qquad ( 11 a )$$

$$16. \leq vdPn \leq 27. \qquad ( 12 a )$$

$$1.3 \leq β Pz / β Pw \times β Nz / β Nw \leq 1.5 \qquad ( 13 a )$$

$$1.1 \leq fPG 1 / fP \leq 1.6 \qquad ( 14 a )$$

Inequalities (1) to (14) may be replaced with the following inequalities (1b) to (14b):

$$1.15 \leq f 1 / fR \leq 1.85 \qquad ( 1 b )$$

$$- 4.2 \leq β Pw \leq - 2. \qquad ( 2 b )$$

$$1.035 \leq β Pt / β Pw \leq 1.135 \qquad ( 3 b )$$

$$0.55 \leq fP / fR \leq 0.85 \qquad ( 4 b )$$

$$- 1.7 \leq fN / fR \leq - 1. \qquad ( 5 b )$$

$$- 0.75 \leq fP / fN \leq - 0.4 \qquad ( 6 b )$$

$$- 3. \leq fP / fV \leq - 2.2 \qquad ( 7 b )$$

$$3.1 \leq fN / fV \leq 6.5 \qquad ( 8 b )$$

$$0.33 \leq β Nw \leq 0.5 \qquad ( 9 b )$$

$$- 0.28 \leq β Nw \leq - 0.2 \qquad ( 10 b )$$

$$1.67 \leq NdPp \leq 1.82 \qquad ( 11 b )$$

$$17. \leq vdPn \leq 25. \qquad ( 12 b )$$

$$1.33 \leq β Pz / β Pw \times β Nz / β Nw \leq 1.46 \qquad ( 13 b )$$

$$1.1 \leq fPG 1 / fP \leq 1.5 \qquad ( 14 b )$$

A specific description will now be given of the zoom lenses according to Examples 1 to 6. After Example 6, numerical examples 1 to 6 corresponding to Examples 1 to 6 will be illustrated. In each numerical example, a surface number i represents the order of the optical surfaces counted from the object side.

### EXAMPLE 1

In a zoom lens according to Example 1 (numerical example 1) illustrated in FIG. 1, the first lens unit L1 has the first to twelfth surfaces, and consists of one negative lens and five positive lenses. The intermediate group LM has thirteenth to twenty-eighth surfaces. The first negative lens unit LV having the thirteenth to twentieth surfaces includes one negative lens having an aspheric lens surface on the object side, two negative lenses, and two positive lenses. The second negative lens unit LN having the twenty-first to twenty-third surfaces includes one negative lens and one positive lens. The positive lens unit LP having the twenty-fourth to twenty-eighth surfaces includes one positive lens having an aspheric lens surface on the image side, one negative lens, and one positive lens. The aperture stop SP has the twenty-ninth surface. The rear lens unit LR has the thirtieth to forty-second surfaces and consists of three negative lenses and five positive lenses.

In numerical example 1, r represents a radius of curvature of an i-th surface (mm), d represents a lens thickness or air gap (mm) between i-th and (i+1)-th surfaces, and nd (Nd) represents an absolute refractive index at 1 atm for the d-line in the Fraunhofer line. νd represents an Abbe number based on the d-line of the optical material between the i-th and (i+1)-th surfaces, and is defined as described above. A half angle of view ω (°) is expressed as follows:

$$ω = arc tan ( Y / fw )$$

where 2Y is the diagonal size of the image sensor of the image pickup apparatus for which the zoom lens is used, and fw is a focal length of the zoom lens at the wide-angle end. The maximum image height (mm) corresponds to Y (for example, 5.50 mm), half of the diagonal size 2Y (for example, 11.00 mm). BF is back focus (mm), which is a distance on the optical axis from the final surface (lens surface closest to the image plane) of the zoom lens to the paraxial image plane expressed by the air equivalent length. An overall lens length (mm) is a distance on the optical axis from the frontmost (foremost) surface of the zoom lens (the lens surface closest to the object) to the final surface plus the back focus.

An asterisk “*” attached to the right side of a surface number means that that optical surface is aspheric. The aspherical shape is expressed as follows:

$$X = \frac{{H}^{2} / R}{1 + \sqrt{1 - ( 1 + k ) {( H / R )}^{2}}} + A 4 {H}^{4} + A 6 {H}^{6} + A 8 {H}^{8} + A 10 {H}^{10} + A 12 {H}^{12} + A 14 {H}^{14} + A 16 {H}^{16} + A 3 {H}^{3} + A 5 {H}^{5} + A 7 {H}^{7} + A 9 {H}^{9} + A 11 {H}^{11} + A 13 {H}^{13} + A 15 {H}^{15}$$

where X is a displacement amount from a surface vertex in the optical axis direction, H is a height from the optical axis in the direction orthogonal to the optical axis, a light traveling direction is set positive, R is a paraxial radius of curvature, K is a conical constant, and A3 to A16 are aspherical coefficients of each order. “e±Z” in each aspherical coefficient means “×10^{±Z}.” WIDE represents the wide-angle end. Za represents a zoom position having a zoom magnification Z^{0.25} where Z is a zoom magnification from the wide-angle end to the telephoto end. MIDDLE represents an intermediate (middle) zoom position, TELE represents a telephoto end.

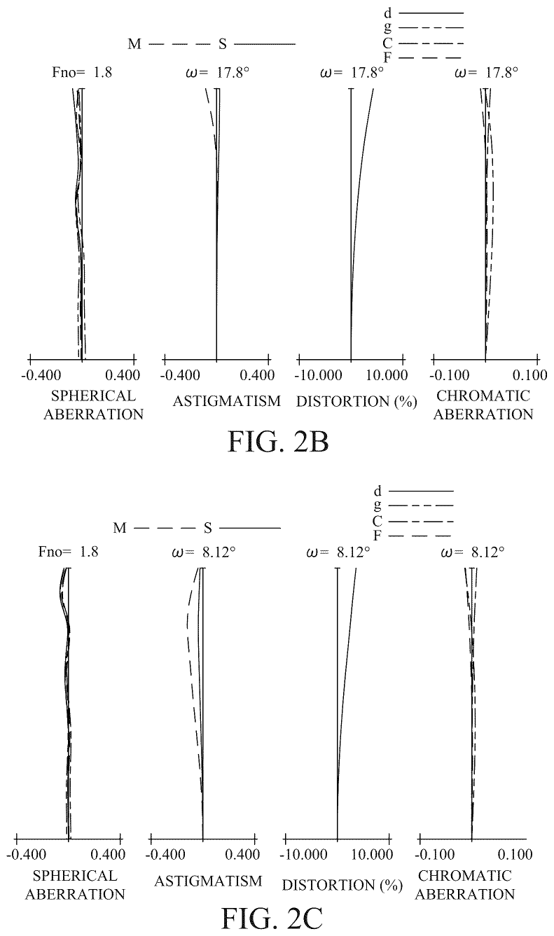

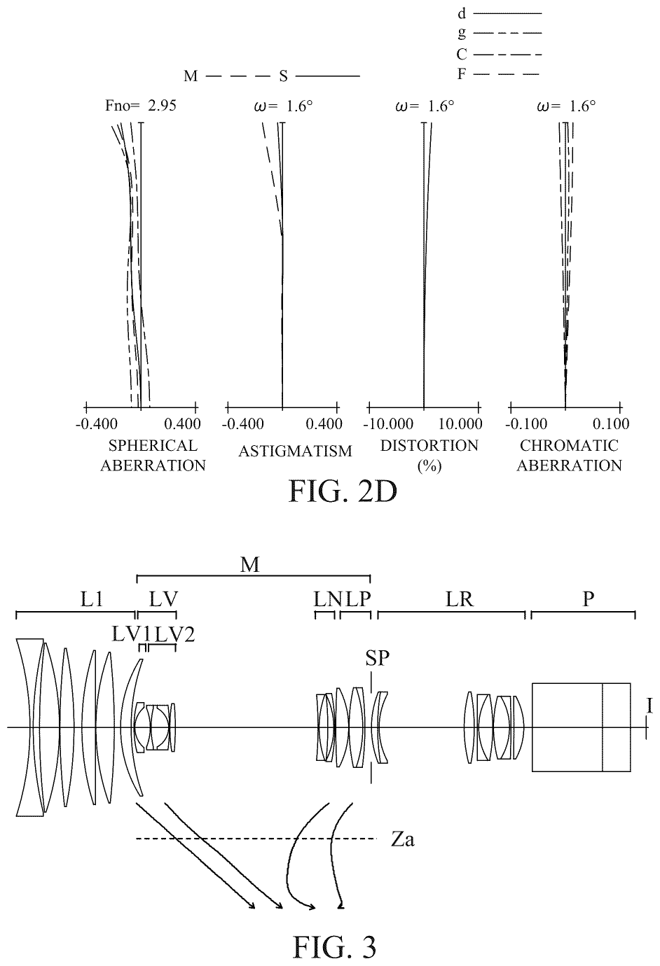

FIGS. 2A, 2B, 2C, and 2D illustrate longitudinal aberrations (spherical aberration, astigmatism, distortion, and chromatic aberration) of the zoom lens according to numerical example 1 in an in-focus state at infinity at a wide-angle end (FIG. 2A), at a zoom position Za (FIG. 2B), at an intermediate zoom position (FIG. 2C), and at a telephoto end (FIG. 2D). The spherical aberration diagram illustrates spherical aberration amounts for the d-line (with a wavelength of 587.6 nm), g-line (with a wavelength of 435.8 nm), C-line (with a wavelength of 656.3 nm), and F-line (with a wavelength of 486.1 nm) using a solid line, an alternate long and two short dashes line, an alternate long and short dash line, and a broken line, respectively. In the astigmatism diagram, a broken line and a solid line indicate astigmatism amounts on a meridional image plane and a sagittal image plane, respectively. The distortion diagram illustrates a distortion amount for the e-line. In the chromatic aberration diagram, a solid line, an alternate long and two short dashes line, an alternate long and short dash line, and a broken line indicate lateral chromatic aberration amounts for the e-line, g-line, C-line, and F-line, respectively. Fno represents an F-number, and ω represents a half angle of view (°). The full scale on the horizontal axis in a spherical aberration diagram is ±0.400 mm. The full scale on the horizontal axis in the astigmatism diagram is also ±0.400 mm. The full scale on the horizontal axis in the distortion aberration diagram is ±10.000%. The full scale on the horizontal axis in the chromatic aberration diagram is ±0.100 mm. The above description of the aberration diagrams is similarly applied to other numerical examples described below.

Table 1 summarizes values of inequalities (1) to (14) in numerical example 1. Table 2 summarizes values of variables included in inequalities (1) to (14) in numerical example 1. The zoom lens according to numerical example 1 satisfies all inequalities (1) to (14) and has a reduced size and weight, a wide angle of view, a high zoom ratio, and high optical performance.

### EXAMPLE 2

FIG. 3 illustrates the configuration of a zoom lens according to Example 2 (numerical example 2) at a wide-angle end in an in-focus state at infinity. In this example, the first lens unit L1 has the first to twelfth surfaces and includes one negative lens and five positive lenses. The intermediate group LM has the thirteenth to thirtieth surfaces. The first negative lens unit LV consists of a first partial lens unit LV1 and a second partial lens unit LV2 arranged in order from the object side. The first partial lens unit LV1 and the second partial lens unit LV2 monotonously move to the image side while changing a distance between them minutely (smaller than a distance change between other lens units) during zooming from the wide-angle end to the telephoto end. The first partial lens unit LV1 has the thirteenth and fourteenth surfaces and includes a single negative lens having an aspheric lens surface on the object side. The second partial lens unit LV2 has the fifteenth to twentieth surfaces and includes two negative lenses and two positive lenses. The second negative lens unit LN has the twenty-first to twenty-fifth surfaces and consists of two negative lenses and one positive lens. The positive lens unit LP has the twenty-sixth to thirtieth surfaces and includes one positive lens having an aspheric lens surface on the object side, one negative lens, and one positive lens. The aperture stop SP has the thirty-first surface. The rear lens unit LR has the thirty-second to forty-fourth surfaces and consists of three negative lenses and five positive lenses. The first negative lens unit LV may include three or more partial lens units.

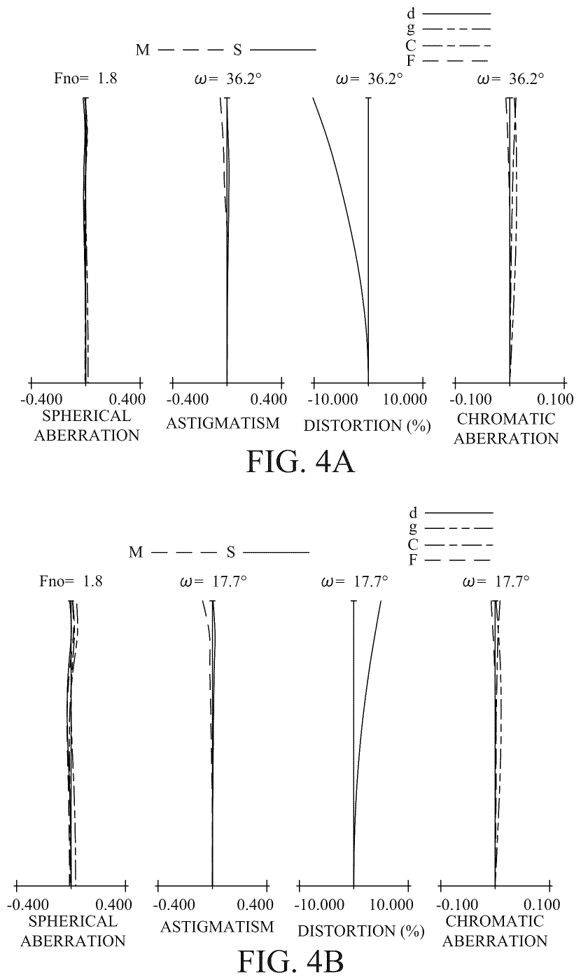

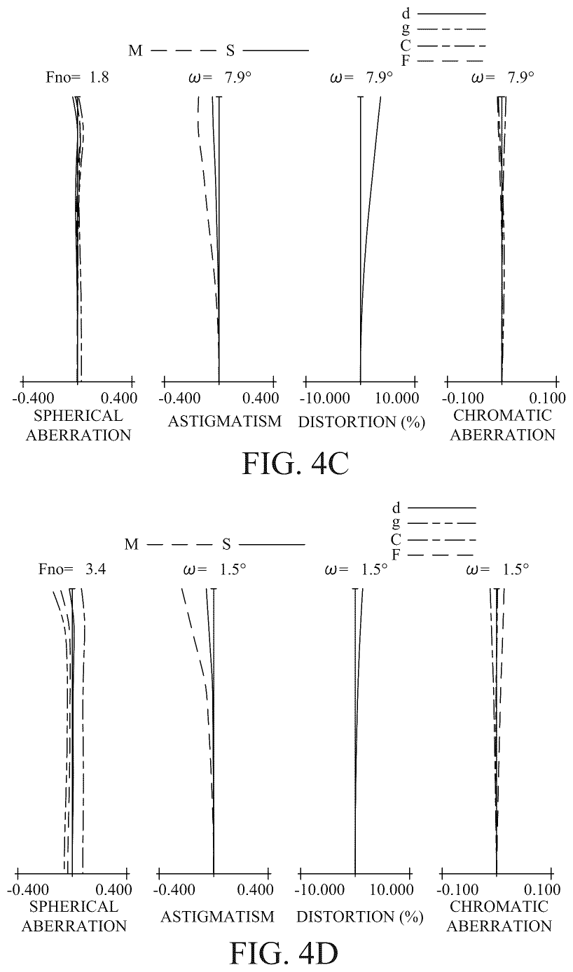

FIGS. 4A, 4B, 4C, and 4D illustrate longitudinal aberrations of the zoom lens according to numerical example 2 in an in-focus state at infinity at a wide-angle end (FIG. 4A), at a zoom position Za (FIG. 4B), at an intermediate zoom position (FIG. 4C), and at a telephoto end (FIG. 4D). Table 1 summarizes values of inequalities (1) to (14) in numerical example 2. Table 2 summarizes values of variables in inequalities (1) to (14) in numerical example 2. The zoom lens according to numerical example 2 satisfies all inequalities (1) to (14) and has a reduced size and weight, a wide angle of view, a high zoom ratio, and high optical performance.

### EXAMPLE 3

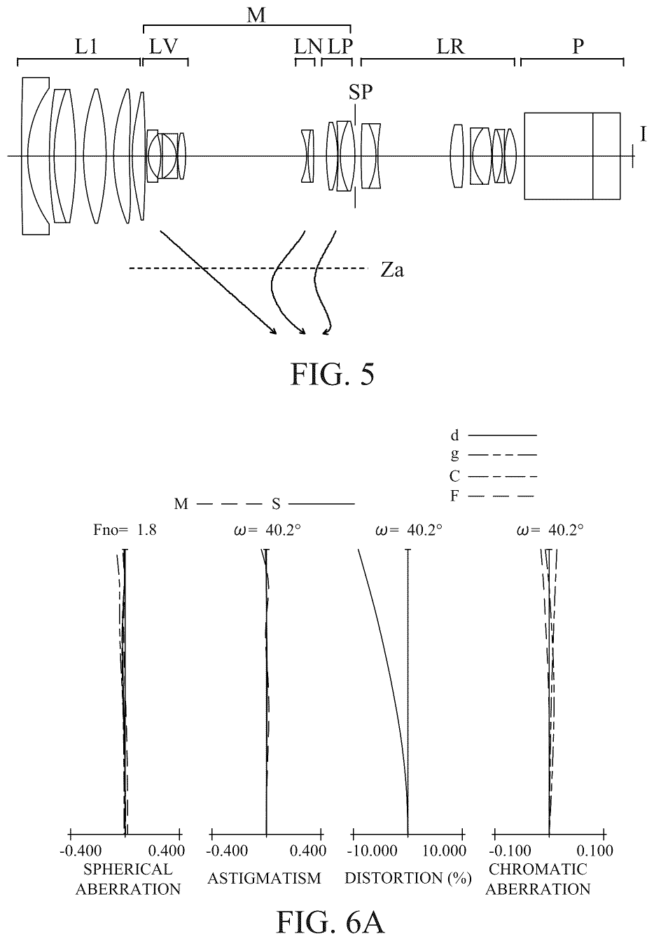

FIG. 5 illustrates the configuration of a zoom lens according to Example 3 (numerical example 3) at a wide-angle end in an in-focus state at infinity. In this example, the first lens unit L1 has the first to eleventh surfaces and includes one negative lens having an aspheric lens surface on the image side, one positive lens having an aspheric lens surface on the image side, one positive lens having an aspheric surface on the object side, and two positive lenses. The intermediate group LM has the twelfth to twenty-seventh surfaces. The first negative lens unit LV has the twelfth to nineteenth surfaces and includes one negative lens having an aspheric lens surface on the object side, two negative lenses, and two positive lenses. The second negative lens unit LN has the twentieth to twenty-second surfaces and includes one negative lens and one positive lens. The positive lens unit LP has the twenty-third to twenty-seventh surfaces and includes one positive lens having an aspheric surface on the object side, one negative lens, and one positive lens. The aperture stop SP has the twenty-eighth surface. The rear lens unit LR has the twenty-ninth to forty-first surfaces and includes three negative lenses and five positive lenses.

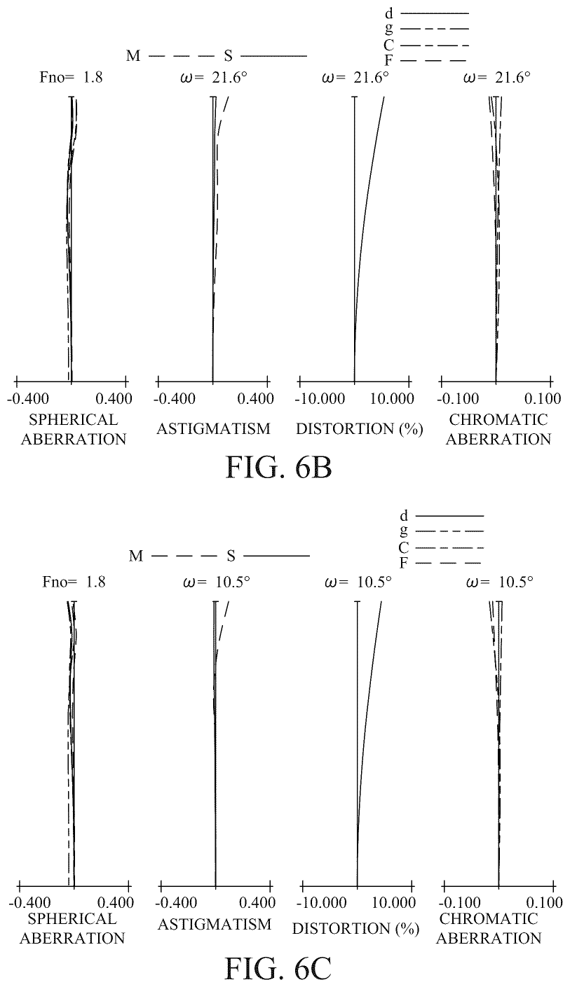

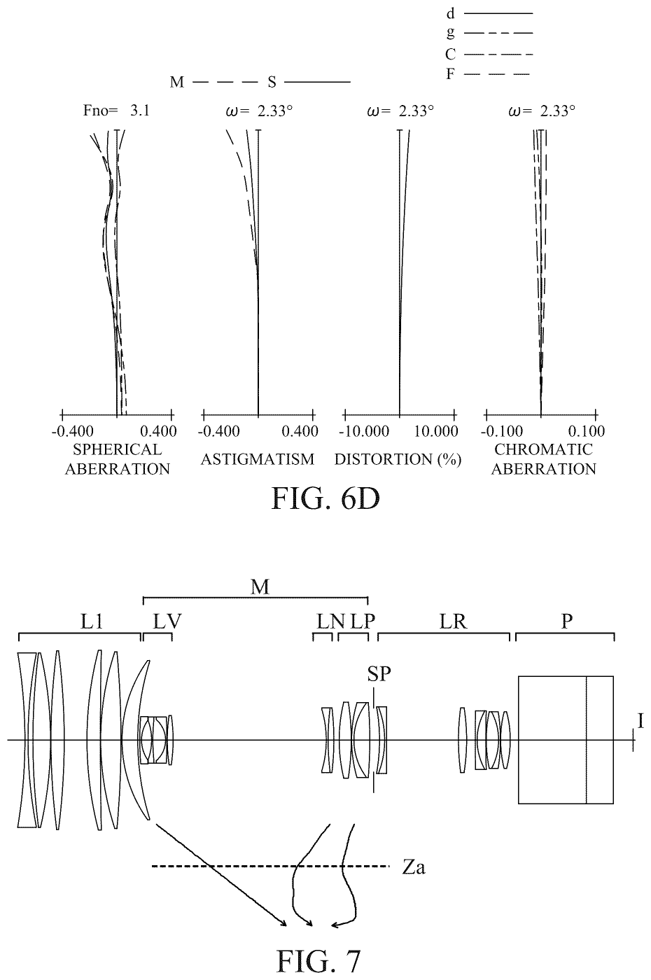

FIGS. 6A, 6B, 6C, and 6D illustrate longitudinal aberrations of the zoom lens according to numerical example 3 in an in-focus state at infinity at a wide-angle end (FIG. 6A), at a zoom position Za (FIG. 6B), at an intermediate zoom position (FIG. 6C), and at a telephoto end (FIG. 6D). Table 1 summarizes values of inequalities (1) to (14) in numerical example 3. Table 2 summarizes values of variables included in inequalities (1) to (14) in numerical example 3. The zoom lens according to numerical example 3 satisfies all inequalities (1) to (14) and has a reduced size and weight, a wide angle of view, a high zoom ratio, and high optical performance.

### EXAMPLE 4

FIG. 7 illustrates the configuration of a zoom lens according to Example 4 (numerical example 4) at a wide-angle end in an in-focus state at infinity. In this example, the first lens unit L1 has the first to twelfth surfaces and includes one negative lens and five positive lenses. The intermediate group LM has the thirteenth to twenty-eighth surfaces. The first negative lens unit LV has the thirteenth to twentieth surfaces and includes one negative lens having an aspheric lens surface on the object side, two negative lenses, and two positive lenses. The second negative lens unit LN has the twenty-first to twenty-third surfaces and includes one negative lens and one positive lens. The positive lens unit LP has the twenty-fourth to twenty-eighth surfaces and includes one positive lens having an aspheric lens surface on the image side, one negative lens, and one positive lens. The aperture stop SP has the twenty-ninth surface. The rear lens unit LR has the thirtieth to forty-second surfaces, and includes three negative lenses and five positive lenses.

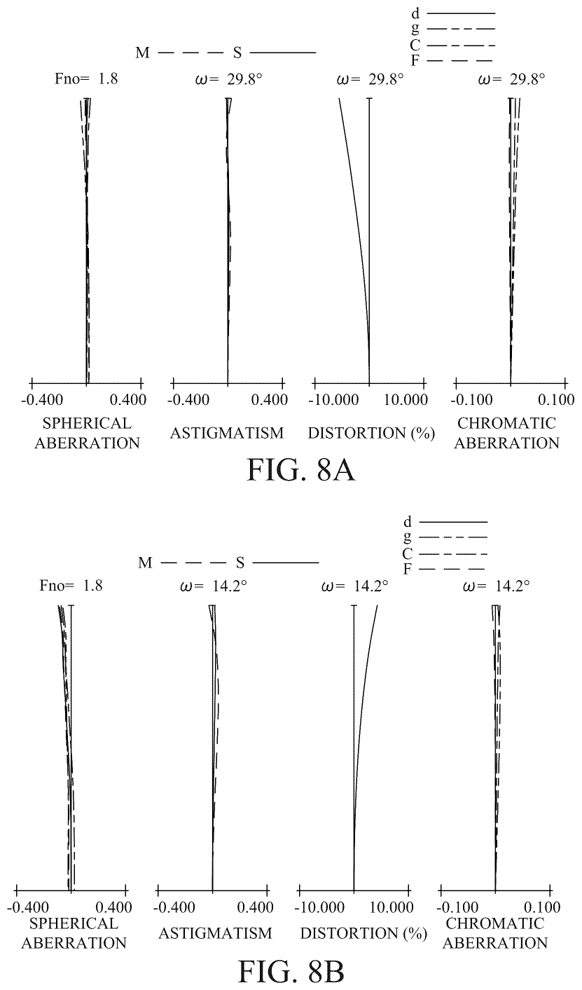

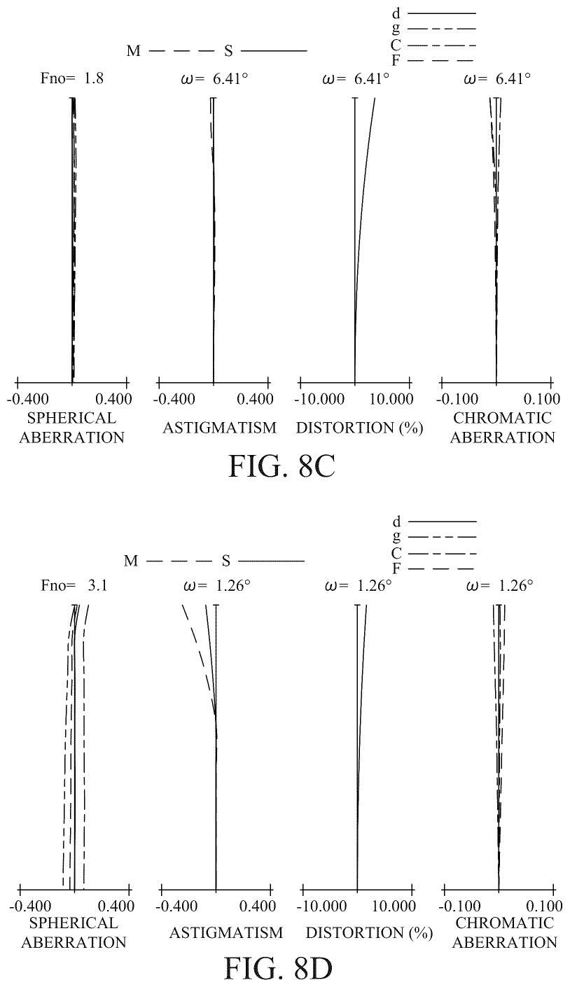

FIGS. 8A, 8B, 8C, and 8D illustrate longitudinal aberrations of the zoom lens according to numerical example 4 in an in-focus state at infinity at a wide-angle end (FIG. 8A), at a zoom position Za (FIG. 8B), at an intermediate zoom position (FIG. 8C), and at a telephoto end (FIG. 8D). Table 1 summarizes values of inequalities (1) to (14) in numerical example 4. Table 2 summarizes values of variables in inequalities (1) to (14) in numerical example 4. The zoom lens according to numerical example 4 satisfies all inequalities (1) to (14) and has a reduced size and weight, a wide angle of view, a high zoom ratio, and high optical performance.

### EXAMPLE 5

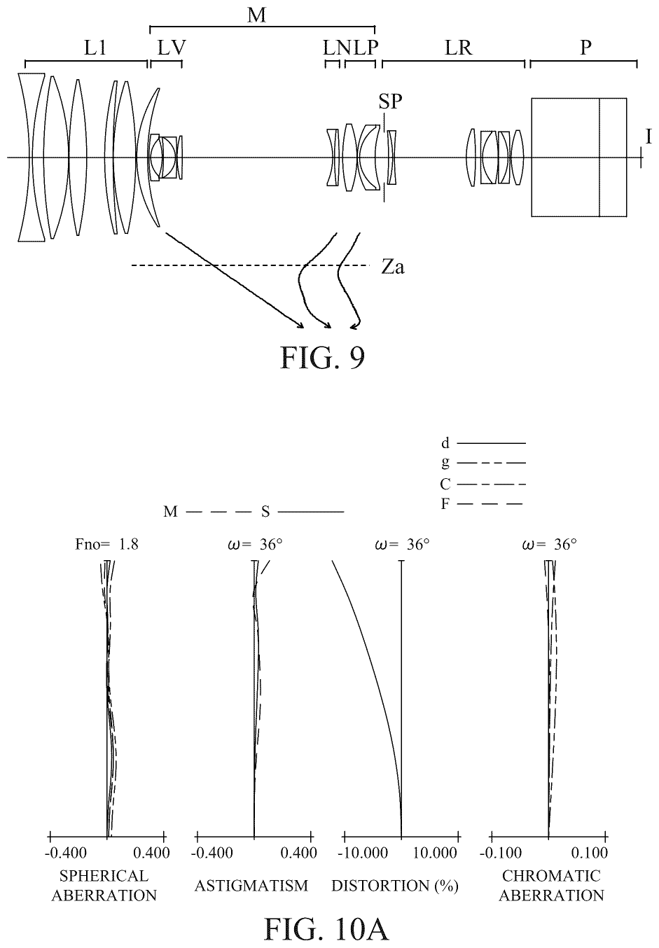

FIG. 9 illustrates the configuration of a zoom lens according to Example 5 (numerical example 5) at the wide-angle end in an in-focus state at infinity. In this example, the first lens unit L1 has the first to twelfth surfaces and includes one negative lens and five positive lenses. The intermediate group LM has the thirteenth to twenty-eighth surfaces. The first negative lens unit LV has the thirteenth to twentieth surfaces and includes one negative lens having an aspheric lens surface on the object side, two negative lenses, and two positive lenses. The second negative lens unit LN has the twenty-first to twenty-third surfaces and includes one negative lens and one positive lens. The positive lens unit LP has the twenty-fourth to twenty-eighth surfaces and includes one positive lens having an aspheric lens surface on the image side, one negative lens, and one positive lens. The aperture stop SP has the twenty-ninth surface. The rear lens unit LR has the thirtieth to forty-second surfaces, and includes three negative lenses and five positive lenses.

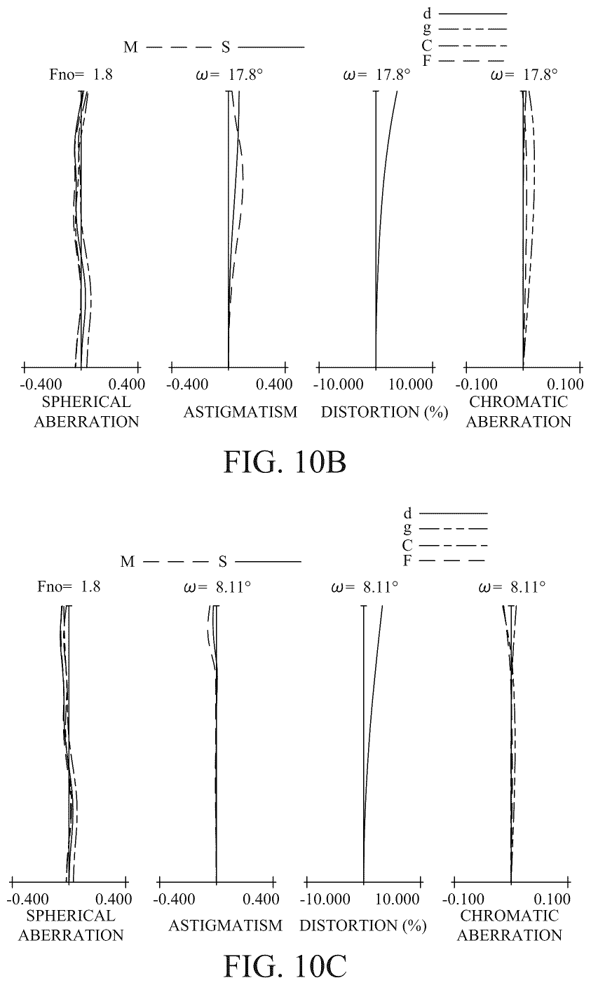

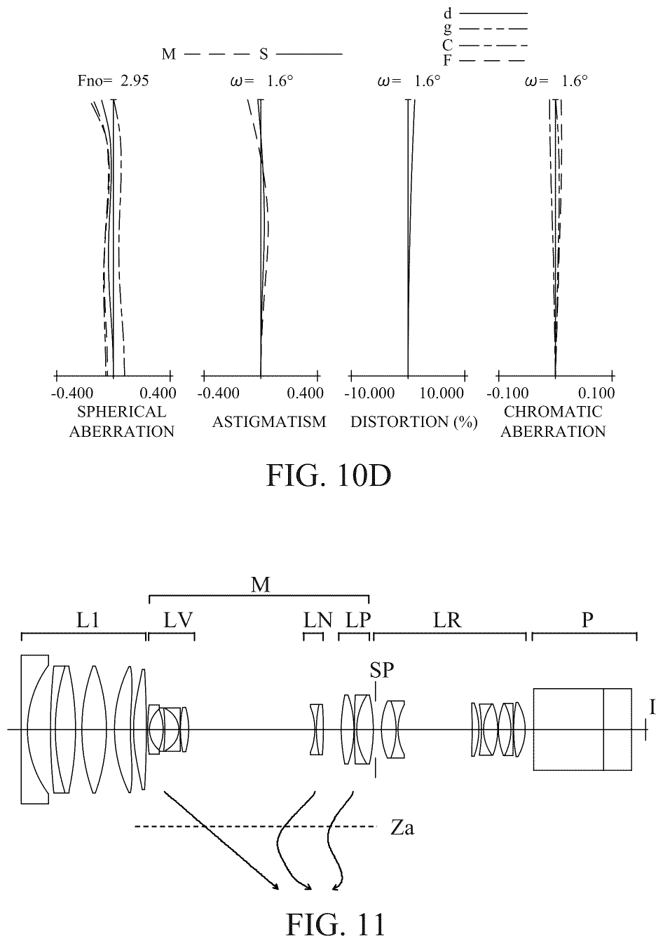

FIGS. 10A, 10B, 10C, and 10D illustrate longitudinal aberrations of the zoom lens according to numerical example 5 in an in-focus state at infinity at a wide-angle end (FIG. 10A), at a zoom position Za (FIG. 10B), at an intermediate zoom position (FIG. 10C), and at a telephoto end (FIG. 10D). Table 1 summarizes values of inequalities (1) to (14) in numerical example 5. Table 2 summarizes values of variables in inequalities (1) to (14) in numerical example 5. The zoom lens according to numerical example 5 satisfies all inequalities (1) to (14) and has a reduced size and weight, a wide angle of view, a high zoom ratio, and high optical performance.

### EXAMPLE 6

FIG. 11 illustrates the configuration of a zoom lens according to Example 6 (numerical example 6) at a wide-angle end in an in-focus state at infinity. In this example, the first lens unit L1 has the first to eleventh surfaces and includes one negative lens having an aspheric lens surface on the image side, one positive lens having an aspheric lens surface on the image side, one positive lens having an aspheric lens surface on the object side, and two positive lenses. The intermediate group LM has the twelfth to twenty-seventh surfaces. The first negative lens unit LV has the twelfth to nineteenth surfaces and includes one negative lens having an aspheric lens surface on the object side, two negative lenses, and two positive lenses. The second negative lens unit LN has the twentieth to twenty-second surfaces and includes one negative lens and one positive lens. The positive lens unit LP has the twenty-third to twenty-seventh surfaces and includes one positive lens having an aspheric lens surface on the object side, one negative lens, and one positive lens. The aperture stop SP has the twenty-eighth surface. The rear lens unit LR has the twenty-ninth to forty-first surfaces and includes three negative lenses and five positive lenses.

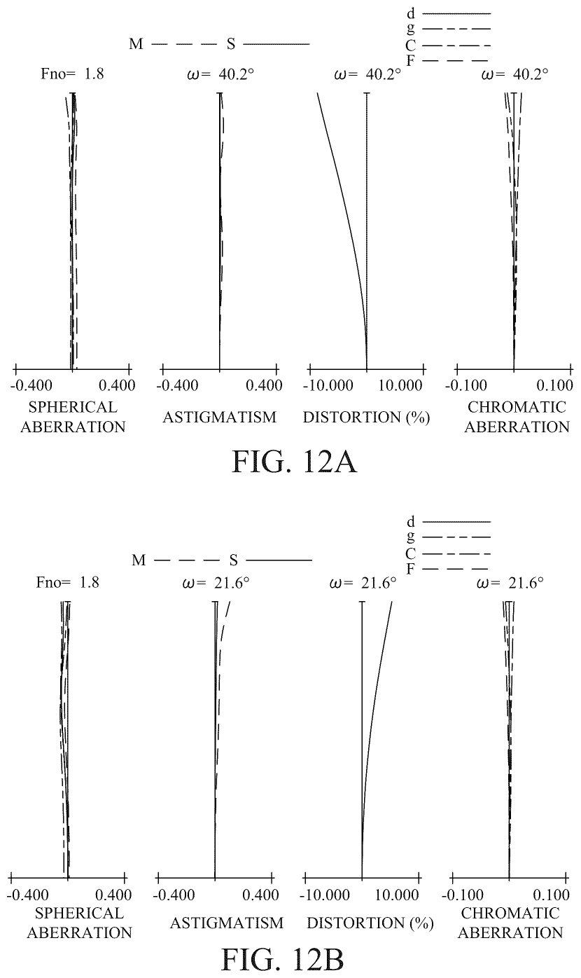

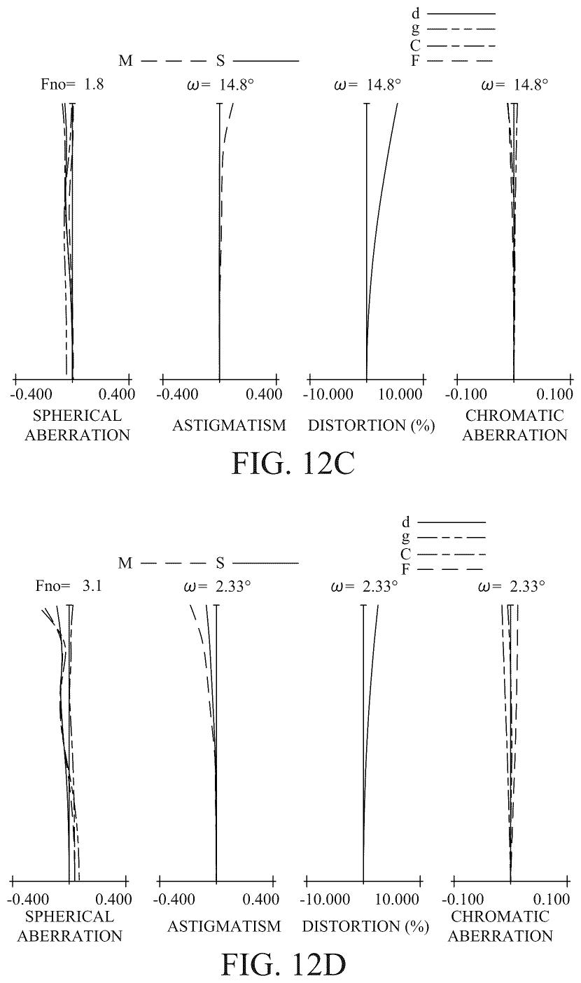

FIGS. 12A, 12B, 12C, and 12D illustrate longitudinal aberrations of the zoom lens according to numerical example 6 in an in-focus state at infinity at a wide-angle end (FIG. 12A), at a zoom position Za (FIG. 12B), at an intermediate zoom position (FIG. 12C), and at a telephoto end (FIG. 12D). Table 1 summarizes values of inequalities (1) to (14) in numerical example 6. Table 2 summarizes values of variables included in inequalities (1) to (14) in numerical example 6. The zoom lens according to numerical example 6 satisfies all inequalities (1) to (14) and has a reduced size and weight, a wide angle of view, a high zoom ratio, and high optical performance.

In the zoom lenses according to Examples 1 to 6, the rear lens unit LR is fixed (does not move) for zooming, but the whole or part of the rear lens unit (partial lens unit) may move. Even in that case, the above effect can be obtained. For example, in Example 1, a portion from the thirty-third surface to the forty-second surface in the rear lens unit LR may be moved. Since an approximately a focal light beam enters the thirty-third surface from the object side, the optical characteristics other than the back focus remain approximately unchanged even if that portion moves. Moving this portion can correct focus changes caused by changes in the state of the zoom lens, such as zooming, focusing, operation of the aperture stop, temperature, atmospheric pressure, orientation, and insertion/removal of the magnification-varying optical system.

### NUMERICAL EXAMPLE 1

UNIT: mm
Surface Data

| Surface | | | | |
|---|---|---|---|---|
| No. | r | d | nd | νd |
| 1 | −149.059 | 1.50 | 1.76634 | 35.8 |
| 2 | 133.529 | 5.10 | | |
| 3 | 181.054 | 11.74 | 1.43387 | 95.1 |
| 4 | −127.668 | 0.20 | | |
| 5 | 257.936 | 7.03 | 1.43387 | 95.1 |
| 6 | −257.936 | 7.09 | | |
| 7 | 165.831 | 5.74 | 1.43387 | 95.1 |
| 8 | 1350.737 | 0.15 | | |
| 9 | 126.151 | 11.11 | 1.43387 | 95.1 |
| 10 | −221.313 | 0.49 | | |
| 11 | 63.698 | 5.87 | 1.76385 | 48.5 |
| 12 | 108.416 | (Variable) | | |
| 13* | 107.013 | 0.85 | 2.05090 | 26.9 |
| 14 | 12.679 | 5.36 | | |
| 15 | −30.111 | 0.60 | 1.88300 | 40.8 |
| 16 | −401.121 | 6.78 | 1.89286 | 20.4 |
| 17 | −10.830 | 0.65 | 2.00100 | 29.1 |
| 18 | −126.500 | 0.18 | | |
| 19 | 53.124 | 2.75 | 1.78472 | 25.7 |
| 20 | −139.718 | (Variable) | | |
| 21 | −36.661 | 0.90 | 1.95375 | 32.3 |
| 22 | 125.708 | 3.28 | 1.92286 | 18.9 |
| 23 | −79.329 | (Variable) | | |
| 24 | 270.503 | 6.86 | 1.77250 | 49.6 |
| 25* | −47.332 | 0.15 | | |
| 26 | 43.458 | 1.10 | 1.89286 | 20.4 |
| 27 | 25.980 | 7.23 | 1.64000 | 60.1 |
| 28 | 201.186 | (Variable) | | |
| 29 (SP) | ∞ | 2.48 | | |
| 30 | −131.227 | 3.40 | 1.84666 | 23.8 |
| 31 | −38.975 | 0.90 | 1.81600 | 46.6 |
| 32 | 519.453 | 35.00 | | |
| 33 | 45.791 | 4.93 | 1.75520 | 27.5 |
| 34 | −176.937 | 2.78 | | |
| 35 | 367.396 | 0.90 | 2.00100 | 29.1 |
| 36 | 22.124 | 6.97 | 1.49700 | 81.5 |
| 37 | −88.326 | 0.20 | | |
| 38 | 357.352 | 4.77 | 1.48749 | 70.2 |
| 39 | −28.360 | 0.90 | 1.88300 | 40.8 |
| 40 | −204.507 | 0.15 | | |
| 41 | 43.617 | 6.23 | 1.48749 | 70.2 |
| 42 | −42.787 | 4.00 | | |
| 43 | ∞ | 33.00 | 1.60859 | 46.4 |
| 44 | ∞ | 13.20 | 1.51633 | 64.1 |
| 45 | ∞ | 6.99 | | |
| Image Plane | ∞ | | | |

Aspheric Data
13th Surface
K = 1.99983e+00 A 4 = 1.77649e−05 A 6 = −5.29341e−08
A 8 = 3.29999e−10 A10 = 1.02584e−11 A12 = −2.22171e−13
A14 = 1.50679e−15 A16 = −3.44562e−18
25th Surface
K = −1.91921e−01 A 4 = 8.11367e−07 A 6 = 7.19921e−09
A 8 = −1.46342e−10 A10 = 1.41032e−12 A12 = −6.88616e−15
A14 = 1.65877e−17 A16 = −1.56715e−20

Various Data
Zoom Ratio 25.91

| | WIDE | Za | MIDDLE | TELE |
|---|---|---|---|---|
| Focal Length: | 7.58 | 17.10 | 38.57 | 196.35 |
| FNO: | 1.80 | 1.80 | 1.80 | 2.95 |
| Half Angle of View (°): | 35.97 | 17.83 | 8.12 | 1.60 |
| Image Height: | 5.50 | 5.50 | 5.50 | 5.50 |
| Overall lens length: | 293.25 | 293.25 | 293.25 | 293.25 |
| BF | 6.99 | 6.99 | 6.99 | 6.99 |
| d12 | 0.70 | 23.04 | 42.85 | 58.25 |
| d20 | 68.05 | 28.02 | 8.39 | 3.40 |
| d23 | 1.81 | 9.94 | 15.76 | 1.10 |
| d28 | 3.17 | 12.73 | 6.73 | 10.98 |

Lens Unit Data

| Unit | Starting Surface | Focal Length |
|---|---|---|
| 1 | 1 | 72.15 |
| 2 | 13 | −12.90 |
| 3 | 21 | −71.58 |
| 4 | 24 | 36.72 |
| 5 | 29 | 52.73 |

### NUMERICAL EXAMPLE 2

UNIT: mm
Surface Data

| Surface | | | | |
|---|---|---|---|---|
| No. | r | d | nd | νd |
| 1 | −138.229 | 1.50 | 1.76626 | 35.9 |
| 2 | 170.362 | 2.98 | | |
| 3 | 335.907 | 9.39 | 1.43387 | 95.1 |
| 4 | −127.445 | 0.20 | | |
| 5 | 316.936 | 6.62 | 1.43387 | 95.1 |
| 6 | −191.782 | 7.10 | | |
| 7 | 122.126 | 6.36 | 1.43387 | 95.1 |
| 8 | −65297.705 | 0.23 | | |
| 9 | 106.103 | 8.66 | 1.43387 | 95.1 |
| 10 | −326.850 | 0.26 | | |
| 11 | 61.310 | 4.93 | 1.76385 | 48.5 |
| 12 | 95.635 | (Variable) | | |
| 13* | 56.294 | 0.40 | 2.05090 | 26.9 |
| 14 | 12.644 | (Variable) | | |
| 15 | −24.661 | 0.40 | 2.00100 | 29.1 |
| 16 | 39.759 | 8.25 | 1.89286 | 20.4 |
| 17 | −10.396 | 0.40 | 2.00100 | 29.1 |
| 18 | −77.835 | 0.18 | | |
| 19 | 72.144 | 2.58 | 1.76182 | 26.5 |
| 20 | −123.904 | (Variable) | | |
| 21 | −163.929 | 0.50 | 1.88300 | 40.8 |
| 22 | 45.749 | 4.07 | 1.84666 | 23.8 |
| 23 | −153.469 | 2.83 | | |
| 24 | −34.563 | 0.50 | 1.88300 | 40.8 |
| 25 | −83.861 | (Variable) | | |
| 26* | 208.843 | 6.11 | 1.72916 | 54.7 |
| 27 | −40.948 | 0.20 | | |
| 28 | 86.741 | 6.44 | 1.64000 | 60.1 |
| 29 | −57.640 | 1.00 | 1.95906 | 17.5 |
| 30 | −146.754 | (Variable) | | |
| 31 (SP) | ∞ | 0.17 | | |
| 32 | 44.845 | 2.92 | 1.84666 | 23.8 |
| 33 | 105.280 | 0.70 | 1.95375 | 32.3 |
| 34 | 33.820 | 40.00 | | |
| 35 | 66.885 | 4.76 | 1.80518 | 25.4 |
| 36 | −90.679 | 1.39 | | |
| 37 | 3681.607 | 0.70 | 1.88300 | 40.8 |
| 38 | 29.299 | 6.61 | 1.48749 | 70.2 |
| 39 | −81.054 | 0.35 | | |
| 40 | 56.549 | 7.52 | 1.43875 | 94.7 |
| 41 | −28.113 | 0.70 | 2.00100 | 29.1 |
| 42 | −373.602 | 1.40 | | |
| 43 | −617.396 | 4.66 | 1.49700 | 81.5 |
| 44 | −30.324 | 4.00 | | |
| 45 | ∞ | 33.00 | 1.60859 | 46.4 |
| 46 | ∞ | 13.20 | 1.51633 | 64.1 |
| 47 | ∞ | 7.41 | | |
| Image Plane | ∞ | | | |

Aspheric Data
13th Surface
K = 1.43462e+00 A 4 = 1.25880e−05 A 6 = 3.38554e−08
A 8 = −2.62158e−09 A10 = 6.34686e−11 A12 = −7.72337e−13
A14 = 4.62697e−15 A16 = −1.08135e−17
26th Surface
K = −1.23985e+00 A 4 = −2.88234e−06 A 6 = 2.02274e−09
A 8 = −4.55937e−12 A10 = 1.02261e−14 A12 = −8.86234e−18

Various Data
Zoom Ratio 27.94

| | WIDE | Za | MIDDLE | TELE |
|---|---|---|---|---|
| Focal Length: | 7.50 | 17.25 | 39.65 | 209.59 |
| FNO: | 1.80 | 1.80 | 1.80 | 3.40 |
| Half Angle of View (°): | 36.25 | 17.69 | 7.90 | 1.50 |
| Image Height: | 5.50 | 5.50 | 5.50 | 5.50 |
| Overall lens length: | 290.00 | 290.00 | 290.00 | 290.00 |
| BF | 7.41 | 7.41 | 7.41 | 7.41 |
| d12 | 0.69 | 22.78 | 40.68 | 56.01 |
| d14 | 7.24 | 6.16 | 6.03 | 6.87 |
| d20 | 67.17 | 29.71 | 8.82 | 5.69 |
| d25 | 0.38 | 6.76 | 11.83 | 0.31 |
| d30 | 2.91 | 12.98 | 11.04 | 9.52 |

Lens Unit Data

| Unit | Starting Surface | Focal Length |
|---|---|---|
| 1 | 1 | 70.97 |
| 2 | 13 | −15.59 |
| 3 | 15 | −50.78 |
| 4 | 21 | −63.38 |
| 5 | 26 | 34.33 |
| 6 | 31 | 57.68 |

### NUMERICAL EXAMPLE 3

UNIT: mm
Surface Data

| Surface No. | r | d | nd | νd |
|---|---|---|---|---|
| 1 | 1161.973 | 3.00 | 1.83481 | 42.7 |
| 2* | 55.708 | 10.48 | | |
| 3 | 202.598 | 2.30 | 1.85478 | 24.8 |
| 4 | 91.753 | 10.37 | 1.43875 | 94.7 |
| 5 | −179.322 | 3.82 | | |
| 6 | 96.636 | 10.91 | 1.43387 | 95.1 |
| 7 | −127.744 | 3.64 | | |
| 8 | 84.532 | 7.63 | 1.43875 | 94.7 |
| 9* | 271.789 | 1.35 | | |
| 10* | 86.189 | 6.25 | 1.76385 | 48.5 |
| 11 | −526.736 | (Variable) | | |
| 12* | 452.536 | 0.80 | 1.95375 | 32.3 |
| 13 | 14.288 | 6.02 | | |
| 14 | −34.746 | 0.80 | 1.88300 | 40.8 |
| 15 | −342.558 | 6.64 | 1.89286 | 20.4 |
| 16 | −12.125 | 0.60 | 1.95375 | 32.3 |
| 17 | 1468.209 | 0.18 | | |
| 18 | 48.950 | 3.77 | 1.62000 | 62.2 |
| 19 | −53.156 | (Variable) | | |
| 20 | −29.258 | 0.75 | 1.71300 | 53.8 |
| 21 | 68.257 | 2.70 | 1.80810 | 22.8 |
| 22 | −266.726 | (Variable) | | |
| 23* | 80.582 | 5.40 | 1.72916 | 54.7 |
| 24 | −54.890 | 0.21 | | |
| 25 | −250.931 | 1.10 | 1.85478 | 24.8 |
| 26 | 40.024 | 7.04 | 1.78336 | 49.5 |
| 27 | −67.274 | (Variable) | | |
| 28 (SP) | ∞ | 2.89 | | |
| 29 | 265.955 | 7.18 | 1.72151 | 29.2 |
| 30 | −36.469 | 0.90 | 1.74100 | 52.6 |
| 31 | 93.872 | 35.00 | | |
| 32 | 57.552 | 6.29 | 1.74840 | 27.7 |
| 33 | −153.418 | 3.49 | | |
| 34 | −1256.618 | 1.00 | 1.88300 | 40.8 |
| 35 | 20.318 | 9.12 | 1.49700 | 81.5 |
| 36 | −54.978 | 0.35 | | |
| 37 | 62.438 | 4.73 | 1.43875 | 94.7 |
| 38 | −32.455 | 1.00 | 2.00100 | 29.1 |
| 39 | 532.156 | 0.21 | | |
| 40 | 44.870 | 5.59 | 1.50137 | 56.4 |
| 41 | −32.096 | 4.00 | | |
| 42 | ∞ | 33.00 | 1.60859 | 46.4 |
| 43 | ∞ | 13.20 | 1.51633 | 64.1 |
| 44 | ∞ | 5.99 | | |
| Image Plane | ∞ | | | |

Aspheric Data
2nd Surface
K = 0.00000e+00 A 4 = −3.88538e−07 A 6 = 1.38805e−10
A 8 = 2.55862e−14 A10 = 9.31507e−18
9th Surface
K = 0.00000e+00 A 4 = −1.35128e−06 A 6 = −4.70579e−10
A 8 = −3.54412e−12 A10 = 7.10965e−15 A12 = −6.18795e−18 A14 =
2.73136e−21 A16 = −4.92221e−25
10th Surface
K = 0.00000e+00 A 4 = −8.86143e−07 A 6 = −3.48567e−10
A 8 = −2.07946e−12 A10 = 3.61558e−15 A12 = −2.85289e−18 A14 =
1.12335e−21 A16 = −1.80823e−25
12th Surface
K = −1.04680e−01 A 4 = 1.21567e−05 A 6 = −4.36047e−08 A
8 = 1.08229e−09 A10 = −1.32183e−11 A12 = 6.48790e−14
A14 = −6.88863e−17 A16 = −2.29401e−19
23rd Surface
K = −9.62925e−01 A 4 = −4.37878e−06 A 6 = 3.49608e−09
A 8 = −9.13154e−12 A10 = 2.27920e−14 A12 = −1.74182e−17

Various Data
Zoom Ratio 20.77

| | WIDE | Za | MIDDLE | TELE |
|---|---|---|---|---|
| Focal Length: | 6.50 | 13.88 | 29.62 | 135.00 |
| FNO: | 1.80 | 1.80 | 1.80 | 3.10 |
| Half Angle of View (°): | 40.24 | 21.62 | 10.52 | 2.33 |
| Image Height: | 5.50 | 5.50 | 5.50 | 5.50 |
| Overall lens length: | 295.00 | 295.00 | 295.00 | 295.00 |
| BF | 5.99 | 5.99 | 5.99 | 5.99 |
| d11 | 0.68 | 21.49 | 39.29 | 56.10 |
| d19 | 58.37 | 23.93 | 5.95 | 3.00 |
| d22 | 6.14 | 10.58 | 13.25 | 0.07 |
| d27 | 0.10 | 9.29 | 6.80 | 6.12 |

Zoom Lens Unit Data

| Unit | Starting Surface | Focal Length |
|---|---|---|
| 1 | 1 | 57.64 |
| 2 | 12 | −15.86 |
| 3 | 20 | −50.52 |
| 4 | 23 | 36.62 |
| 5 | 28 | 49.58 |

### NUMERICAL EXAMPLE 4

UNIT: mm
Surface Data

| Surface No. | r | d | nd | νd |
|---|---|---|---|---|
| 1 | −256.838 | 1.50 | 1.76634 | 35.8 |
| 2 | 222.862 | 2.38 | | |
| 3 | 334.659 | 8.58 | 1.43387 | 95.1 |
| 4 | −186.280 | 0.20 | | |
| 5 | 343.327 | 6.45 | 1.43387 | 95.1 |
| 6 | −343.327 | 11.05 | | |
| 7 | 175.189 | 6.53 | 1.43387 | 95.1 |
| 8 | 2162.879 | 0.15 | | |
| 9 | 137.912 | 9.89 | 1.43387 | 95.1 |
| 10 | −467.176 | 0.50 | | |
| 11 | 66.528 | 7.65 | 1.59522 | 67.7 |
| 12 | 129.470 | (Variable) | | |
| 13* | 163.386 | 0.85 | 2.05090 | 26.9 |
| 14 | 16.856 | 4.90 | | |
| 15 | −27.664 | 0.60 | 1.88300 | 40.8 |
| 16 | 95.438 | 6.19 | 1.89286 | 20.4 |
| 17 | −13.318 | 0.65 | 2.00100 | 29.1 |
| 18 | −200.925 | 0.18 | | |
| 19 | 80.066 | 2.84 | 1.76182 | 26.5 |
| 20 | −81.580 | (Variable) | | |
| 21 | −52.823 | 0.90 | 1.95375 | 32.3 |
| 22 | 129.643 | 2.81 | 1.92286 | 18.9 |
| 23 | −129.028 | (Variable) | | |
| 24 | 77.398 | 5.91 | 1.90525 | 35.0 |
| 25* | −104.234 | 0.15 | | |
| 26 | 65.263 | 1.10 | 1.89286 | 20.4 |
| 27 | 29.834 | 7.72 | 1.59522 | 67.7 |
| 28 | −228.980 | (Variable) | | |
| 29 (SP) | ∞ | 2.85 | | |
| 30 | −92.495 | 2.51 | 1.80518 | 25.4 |
| 31 | −45.005 | 0.90 | 1.77250 | 49.6 |
| 32 | 10197.579 | 35.00 | | |
| 33 | 118.263 | 3.98 | 1.84666 | 23.8 |
| 34 | −101.816 | 4.21 | | |
| 35 | 1283.311 | 0.90 | 2.00100 | 29.1 |
| 36 | 28.789 | 4.23 | 1.49700 | 81.5 |
| 37 | 455.217 | 0.20 | | |
| 38 | 65.251 | 6.02 | 1.48749 | 70.2 |
| 39 | −29.453 | 0.90 | 1.88300 | 40.8 |
| 40 | −85.362 | 0.08 | | |
| 41 | 56.395 | 4.69 | 1.48749 | 70.2 |
| 42 | −53.551 | 4.00 | | |
| 43 | ∞ | 33.00 | 1.60859 | 46.4 |
| 44 | ∞ | 13.20 | 1.51633 | 64.1 |
| 45 | ∞ | 9.59 | | |
| Image Plane | ∞ | | | |

Aspheric Data
13th Surface
K = 2.00022e+00 A 4 = 3.63392e−06 A 6 = 1.32125e−08
A 8 = −6.95629e−10 A10 = 1.57692e−11 A12 = −1.79024e−13
A14 = 9.45740e−16 A16 = −1.86493e−18
25th Surface
K = 1.46007e+00 A 4 = 1.61906e−06 A 6 = −2.91965e−10
A 8 = −1.35714e−12 A10 = 3.16592e−14 A12 = −1.98539e−16
A14 = 5.38317e−19 A16 = −5.45265e−22

Various Data
Zoom Ratio 25.93

| | WIDE | Za | MIDDLE | TELE |
|---|---|---|---|---|
| Focal Length: | 9.61 | 21.68 | 48.92 | 249.13 |
| FNO: | 1.80 | 1.80 | 1.80 | 3.10 |
| Half Angle of View (°): | 29.79 | 14.24 | 6.41 | 1.26 |
| Image Height: | 5.50 | 5.50 | 5.50 | 5.50 |
| Overall lens length: | 295.91 | 295.91 | 295.91 | 295.91 |
| BF | 9.59 | 9.59 | 9.59 | 9.59 |
| d12 | 1.00 | 27.61 | 48.74 | 64.19 |
| d20 | 74.52 | 32.07 | 8.89 | 2.55 |
| d23 | 2.57 | 12.69 | 20.59 | 0.77 |
| d28 | 1.89 | 7.61 | 1.76 | 12.47 |

Lens Unit Data

| Unit | Starting Surface | Focal Length |
|---|---|---|
| 1 | 1 | 88.49 |
| 2 | 13 | −14.64 |
| 3 | 21 | −91.80 |
| 4 | 24 | 38.51 |
| 5 | 29 | 55.50 |

### NUMERICAL EXAMPLE 5

UNIT: mm
Surface Data

| Surface No. | r | d | nd | νd |
|---|---|---|---|---|
| 1 | −181.984 | 1.50 | 1.89190 | 37.1 |
| 2 | 155.032 | 5.48 | | |
| 3 | 250.252 | 12.17 | 1.43387 | 95.1 |
| 4 | −125.457 | 0.20 | | |
| 5 | 216.137 | 8.61 | 1.43387 | 95.1 |
| 6 | −216.137 | 8.75 | | |
| 7 | 171.028 | 4.09 | 1.43387 | 95.1 |
| 8 | 392.073 | 0.15 | | |
| 9 | 140.137 | 10.93 | 1.43387 | 95.1 |
| 10 | −201.671 | 0.50 | | |
| 11 | 69.300 | 5.24 | 1.76385 | 48.5 |
| 12 | 112.969 | (Variable) | | |
| 13* | 86.122 | 0.85 | 2.05090 | 26.9 |
| 14 | 14.236 | 5.60 | | |
| 15 | −31.083 | 0.60 | 1.88300 | 40.8 |
| 16 | −94.504 | 5.84 | 1.89286 | 20.4 |
| 17 | −12.292 | 0.65 | 1.95375 | 32.3 |
| 18 | −212.514 | 0.18 | | |
| 19 | 46.944 | 2.45 | 1.78472 | 25.7 |
| 20 | −723.914 | (Variable) | | |
| 21 | −35.682 | 0.90 | 1.81600 | 46.6 |
| 22 | 128.627 | 2.22 | 1.92286 | 18.9 |
| 23 | −195.186 | (Variable) | | |
| 24 | 80.794 | 7.00 | 1.89190 | 37.1 |
| 25* | −52.693 | 0.15 | | |
| 26 | 37.251 | 1.10 | 1.89286 | 20.4 |
| 27 | 19.691 | 7.54 | 1.69680 | 55.5 |
| 28 | 53.265 | (Variable) | | |
| 29 (SP) | ∞ | 2.13 | | |
| 30 | −187.673 | 2.00 | 1.84666 | 23.8 |
| 31 | −58.254 | 0.90 | 1.81600 | 46.6 |
| 32 | 139.272 | 35.00 | | |
| 33 | 44.026 | 4.48 | 1.80518 | 25.4 |
| 34 | −150.648 | 2.53 | | |
| 35 | 661.761 | 0.90 | 2.00100 | 29.1 |
| 36 | 21.270 | 7.63 | 1.49700 | 81.5 |
| 37 | −66.012 | 0.20 | | |
| 38 | −1853.388 | 4.60 | 1.48749 | 70.2 |
| 39 | −27.955 | 0.90 | 1.88300 | 40.8 |
| 40 | −313.116 | 0.65 | | |
| 41 | 42.360 | 5.99 | 1.61800 | 63.3 |
| 42 | −53.282 | 4.00 | | |
| 43 | ∞ | 33.00 | 1.60859 | 46.4 |
| 44 | ∞ | 13.20 | 1.51633 | 64.1 |
| 45 | ∞ | 7.00 | | |
| Image Plane | ∞ | | | |

Aspheric Data
13th Surface
K = −1.98844e+00 A 4 = 7.87117e−06 A 6 = −1.22539e−07
A 8 = 2.94216e−09 A10 = −3.94132e−11 A12 = 3.02524e−13
A14 = −1.29708e−15 A16 = 2.41234e−18
25th Surface
K = −1.65386e+00 A 4 = 1.79075e−06 A 6 = −1.27701e−08
A 8 = 1.64963e−10 A10 = −1.11398e−12 A12 = 4.10809e−15
A14 = −7.82974e−18 A16 = 6.01640e−21

Various Data
Zoom Ratio 25.91

| | WIDE | Za | MIDDLE | TELE |
|---|---|---|---|---|
| Focal Length: | 7.58 | 17.10 | 38.57 | 196.34 |
| FNO: | 1.80 | 1.80 | 1.80 | 2.95 |
| Half Angle of View (°): | 35.97 | 17.83 | 8.11 | 1.60 |
| Image Height: | 5.50 | 5.50 | 5.50 | 5.50 |
| Overall lens length: | 298.03 | 298.03 | 298.03 | 298.03 |
| BF | 7.00 | 7.00 | 7.00 | 7.00 |
| d12 | 0.70 | 25.57 | 48.04 | 67.15 |
| d20 | 73.35 | 32.22 | 10.30 | 3.55 |
| d23 | 1.74 | 7.89 | 12.88 | 0.75 |
| d28 | 4.43 | 14.56 | 9.02 | 8.78 |

Lens Unit Data

| Unit | Starting Surface | Focal Length |
|---|---|---|
| 1 | 1 | 80.49 |
| 2 | 13 | −14.47 |
| 3 | 21 | −58.39 |
| 4 | 24 | 32.04 |
| 5 | 29 | 44.71 |

### NUMERICAL EXAMPLE 6

UNIT: mm
Surface Data

| Surface No. | r | d | nd | νd |
|---|---|---|---|---|
| 1 | 6844.443 | 3.00 | 1.83481 | 42.7 |
| 2* | 59.066 | 10.88 | | |
| 3 | 331.428 | 2.30 | 1.85478 | 24.8 |
| 4 | 114.762 | 9.53 | 1.43875 | 94.7 |
| 5 | −159.231 | 2.99 | | |
| 6 | 102.450 | 11.62 | 1.43387 | 95.1 |
| 7 | −101.356 | 3.79 | | |
| 8 | 78.335 | 7.57 | 1.43875 | 94.7 |
| 9* | 199.521 | 1.45 | | |
| 10* | 86.528 | 6.03 | 1.76385 | 48.5 |
| 11 | −573.158 | (Variable) | | |
| 12* | 168.483 | 0.80 | 1.95375 | 32.3 |
| 13 | 14.163 | 6.44 | | |
| 14 | −28.430 | 0.80 | 1.88300 | 40.8 |
| 15 | −117.446 | 6.61 | 1.89286 | 20.4 |
| 16 | −12.029 | 0.60 | 1.95375 | 32.3 |
| 17 | 546.801 | 0.18 | | |
| 18 | 59.873 | 3.88 | 1.72916 | 54.7 |
| 19 | −46.246 | (Variable) | | |
| 20 | −33.172 | 0.75 | 1.72916 | 54.7 |
| 21 | 66.895 | 3.33 | 1.76182 | 26.5 |
| 22 | −162.943 | (Variable) | | |
| 23* | 79.209 | 6.02 | 1.72916 | 54.7 |
| 24 | −56.145 | 0.21 | | |
| 25 | 363.711 | 1.10 | 1.85478 | 24.8 |
| 26 | 34.422 | 7.83 | 1.72916 | 54.7 |
| 27 | −82.536 | (Variable) | | |
| 28 (SP) | ∞ | 2.89 | | |
| 29 | 38.937 | 6.92 | 1.76182 | 26.5 |
| 30 | −42.985 | 0.90 | 1.88300 | 40.8 |
| 31 | 28.658 | 35.00 | | |
| 32 | −509.758 | 3.19 | 1.78472 | 25.7 |
| 33 | −41.649 | 1.21 | | |
| 34 | −86.814 | 1.00 | 1.88300 | 40.8 |
| 35 | 23.117 | 6.68 | 1.49700 | 81.5 |
| 36 | −38.636 | 0.35 | | |
| 37 | 37.465 | 5.92 | 1.43875 | 94.7 |
| 38 | −30.367 | 1.00 | 2.00100 | 29.1 |
| 39 | −1587.945 | 0.25 | | |
| 40 | 80.553 | 5.47 | 1.54814 | 45.8 |
| 41 | −29.073 | 4.00 | | |
| 42 | ∞ | 33.00 | 1.60859 | 46.4 |
| 43 | ∞ | 13.20 | 1.51633 | 64.1 |
| 44 | ∞ | 6.70 | | |
| Image Plane | ∞ | | | |

Aspheric Data
2nd Surface
K = 0.00000e+00 A 4 = −1.12936e−07 A 6 = 4.60421e−11
A 8 = 1.94184e−13 A10 = −7.11742e−17
9th Surface
K = 0.00000e+00 A 4 = −1.86684e−06 A 6 = 1.03061e−09
A 8 = −7.08544e−12 A10 = 1.15646e−14 A12 = −9.29309e−18
A14 = 3.73790e−21 A16 = −5.61112e−25
10th Surface
K = 0.00000e+00 A 4 = −1.15556e−06 A 6 = 5.07612e−10
A 8 = −4.13561e−12 A10 = 6.18471e−15 A12 = −4.52503e−18
A14 = 1.45630e−21 A16 = −8.81204e−26
12th Surface
K = 1.99863e+00 A 4 = 1.01068e−05 A 6 = −5.57571e−08
A 8 = 1.45679e−09 A10 = −2.09628e−11 A12 = 1.52735e−13
A14 = −5.62932e−16 A16 = 8.44126e−19
23rd Surface
K = 1.48811e+00 A 4 = −3.99094e−06 A 6 = 2.67211e−09
A 8 = −8.61326e−12 A10 = 2.61385e−14 A12 = −3.08373e−17

Various Data
Zoom Ratio 20.77

| | WIDE | Za | MIDDLE | TELE |
|---|---|---|---|---|
| Focal Length: | 6.50 | 13.88 | 20.77 | 135.00 |
| FNO: | 1.80 | 1.80 | 1.80 | 3.10 |
| Half Angle of View (°): | 40.24 | 21.62 | 14.83 | 2.33 |
| Image Height: | 5.50 | 5.50 | 5.50 | 5.50 |
| Overall lens length: | 295.01 | 295.01 | 295.01 | 295.01 |
| BF | 6.70 | 6.70 | 6.70 | 6.70 |
| d11 | 0.68 | 19.51 | 29.21 | 54.54 |
| d19 | 59.58 | 26.75 | 13.46 | 3.81 |
| d22 | 8.39 | 11.80 | 14.28 | 0.48 |
| d27 | 0.97 | 11.58 | 12.68 | 10.79 |

Lens Unit Data

| Unit | Starting Surface | Focal Length |
|---|---|---|
| 1 | 1 | 57.22 |
| 2 | 12 | −16.15 |
| 3 | 20 | −60.32 |
| 4 | 23 | 35.54 |
| 5 | 28 | 44.11 |

TABLE 1

| | | | Numerical Example | | | | | |
|---|---|---|---|---|---|---|---|---|
| | | | 1 | 2 | 3 | 4 | 5 | 6 |
| Inequality | (1) | f1/fR | 1.368 | 1.230 | 1.163 | 1.594 | 1.800 | 1.297 |
| | (2) | βPw | −2.88 | −3.53 | −4.11 | −2.15 | −3.51 | −2.07 |
| | (3) | βPt/βPw | 1.074 | 1.055 | 1.040 | 1.128 | 1.039 | 1.133 |
| | (4) | fP/fR | 0.696 | 0.595 | 0.739 | 0.694 | 0.717 | 0.806 |
| | (5) | fN/fR | −1.357 | −1.099 | −1.019 | −1.654 | −1.306 | −1.367 |
| | (6) | fP/fN | −0.513 | −0.542 | −0.725 | −0.420 | −0.549 | −0.589 |
| | (7) | fP/fv | −2.846 | −2.960 | −2.309 | −2.631 | −2.214 | −2.201 |
| | (8) | fN/fv | 5.548 | 5.464 | 3.185 | 6.270 | 4.035 | 3.735 |
| | (9) | βNw | 0.429 | 0.389 | 0.348 | 0.471 | 0.363 | 0.383 |
| | (10) | βVw | −0.215 | −0.202 | −0.277 | −0.222 | −0.209 | −0.288 |
| | (11) | NdPp | 1.706 | 1.685 | 1.756 | 1.750 | 1.794 | 1.729 |
| | (12) | VdPn | 20.36 | 17.47 | 24.8 | 20.36 | 20.36 | 24.8 |
| | (13) | βPz/βPw × | 1.417 | 1.396 | 1.360 | 1.348 | 1.444 | 1.419 |
| | | βNz/βNw | | | | | | |
| | (14) | fPG1/fP | 1.434 | 1.382 | 1.244 | 1.294 | 1.145 | 1.292 |

TABLE 2

| | Numerical Example | | | | | |
|---|---|---|---|---|---|---|
| | 1 | 2 | 3 | 4 | 5 | 6 |
| f1 | 72.153 | 70.969 | 57.642 | 88.491 | 80.491 | 57.223 |
| fV | −12.901 | −11.600 | −15.862 | −14.641 | −14.470 | −16.149 |
| fN | −71.582 | −63.385 | −50.516 | −91.803 | −58.388 | −60.319 |
| fP | 36.717 | 34.331 | 36.617 | 38.515 | 32.035 | 35.538 |
| fR | 52.733 | 57.679 | 49.578 | 55.502 | 44.707 | 44.109 |
| βVw | −0.215 | −0.202 | −0.277 | −0.222 | −0.209 | −0.288 |
| βNw | 0.429 | 0.389 | 0.348 | 0.471 | 0.363 | 0.383 |
| βNz | 0.558 | 0.502 | 0.446 | 0.594 | 0.481 | 0.475 |
| βPw | −2.875 | −3.527 | −4.115 | −2.145 | −3.507 | −2.074 |
| βPz | −3.136 | −3.820 | −4.365 | −2.294 | −3.823 | −2.372 |
| βPt | −3.088 | −3.719 | −4.279 | −2.420 | −3.643 | −2.350 |
| NdPp | 1.706 | 1.685 | 1.756 | 1.750 | 1.794 | 1.729 |
| VdPn | 20.360 | 17.470 | 24.800 | 20.360 | 20.360 | 24.800 |
| fPG1 | 52.642 | 47.442 | 45.543 | 49.837 | 36.665 | 45.921 |

### Image Pickup Apparatus

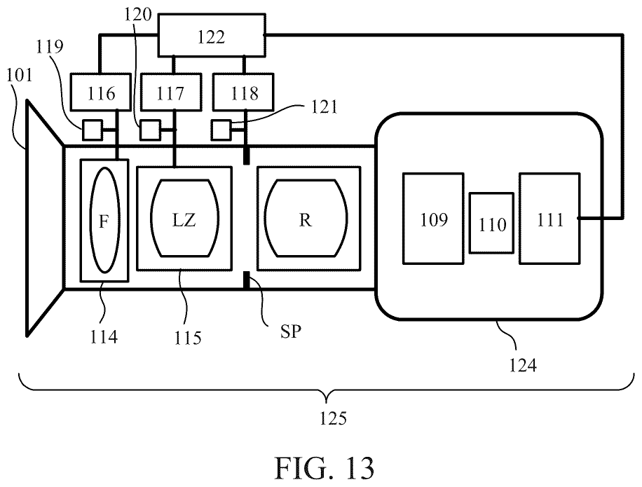

FIG. 13 illustrates a configuration example of the image pickup apparatus 125. In FIG. 13, reference numeral 101 denotes a zoom lens according to any one of Examples 1 to 6. Reference numeral 124 denotes a camera body. The zoom lens 101 is attached to and detachable from the camera body 124. In FIG. 13, the first lens unit L1 is illustrated as a lens unit F, an intermediate group M is illustrated as a lens unit LZ, and the rear lens unit LR is illustrated as a lens unit R. SP represents an aperture stop, and reference numerals 114 and 115 denote driving mechanisms for driving the focusing lens unit and the zooming lens unit, and include a helicoid, a cam, and the like. Reference numerals 116 to 118 denote motors (actuators) configured to drive the driving mechanisms 114 and 115 and the aperture stop SP. Detectors 119 to 121 detect the positions of the lens unit for focusing and the lens unit LZ and the aperture diameter of the aperture stop SP, and include encoders, potentiometers, photosensors, and the like.

In the camera body 124, reference numeral 109 denotes a glass block marked with P according to Examples 1 to 6. Reference numeral 110 denotes an image sensor (photoelectric conversion element) such as a CCD sensor or a CMOS sensor that photoelectrically converts (captures) a subject image formed by the zoom lens 101. Reference numerals 111 and 122 denote processing units that perform various processes and controls in the camera body 124 and the zoom lens 101, respectively, and include a processor such as a CPU.

Using the zoom lens according to any one of Examples 1 to 6 can provide the image pickup apparatus 125 that has a reduced size and weight and can provide excellent captured images.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide a zoom lens that has a reduced size and weight, a wide angle of view, a high zoom ratio, and high optical performance.

This application claims priority to Japanese Patent Application No. 2023-080331, which was filed on May 15, 2023, and which is hereby incorporated by reference herein in its entirety.

What is claimed is:

1. A zoom lens comprising, in order from an object side to an image side:
a first lens unit having positive refractive power and fixed for zooming;
an intermediate group including three or more lens units that move for zooming;
a rear lens unit having positive refractive power and fixed for zooming,
wherein a distance between adjacent lens units changes during zooming,
wherein the intermediate group includes:
a first negative lens unit having negative refractive power as a whole and including a single lens unit or two or more partial lens units configured to monotonically move toward the image side during zooming from a wide-angle end to a telephoto end;
a positive lens unit having positive refractive power, disposed closest to an image plane, and configured to move during zooming; and
a second negative lens unit having negative refractive power, disposed on the object side of the positive lens, and configured to move during zooming, and
wherein the following inequalities are satisfied:
$$\begin{matrix}1. \leq f 1 / fR \leq 2.00 \\ - 5. \leq β P w \leq - 1.\end{matrix}$$
where f1 is a focal length of the first lens unit, fR is a focal length of the rear lens unit, and βPw is a lateral magnification of the positive lens unit at the wide-angle end.

2. The zoom lens according to claim 1, wherein the following inequality is satisfied:
$$1. 01 \leq β Pt / β Pw \leq 1.2$$
where βPt is a lateral magnification of the positive lens unit at the telephoto end.

3. The zoom lens according to claim 1, wherein the following inequality is satisfied:
$$0.30 \leq fP / fR \leq 1.$$
where fP is a focal length of the positive lens unit.

4. The zoom lens according to claim 1, wherein the following inequality is satisfied:
$$- 3. \leq fN / fR \leq - 0.50$$
where fN is a focal length of the second negative lens unit.

5. The zoom lens according to claim 1, wherein the following inequality is satisfied:
$$- 1. \leq fP / fN \leq - 0.20$$
where fP is a focal length of the positive lens unit, and fN is a focal length of the second negative lens unit.

6. The zoom lens according to claim 1, wherein the following inequality is satisfied:
$$- 4.00 \leq fP / fV \leq - 1.5$$
where fV is a focal length of the first negative lens unit at the wide-angle end, and fP is a focal length of the positive lens unit.

7. The zoom lens according to claim 1, wherein the following inequality is satisfied:
$$2.00 \leq fN / fV \leq 10.00$$
where fV is a focal length of the first negative lens unit at the wide-angle end, and fN is a focal length of the second negative lens unit.

8. The zoom lens according to claim 1, wherein the following inequality is satisfied:
$$0.2 \leq β N w \leq 0.80$$
where βNw is a lateral magnification of the second negative lens unit at the wide-angle end.

9. The zoom lens according to claim 1, wherein the following inequality is satisfied:
$$- 0.35 \leq β V w \leq - 0.15$$
where βVw is a lateral magnification of the first negative lens unit at the wide-angle end.

10. The zoom lens according to claim 1, wherein the following inequality is satisfied:
$$1.6 \leq NdPp \leq 1.9$$
where NdPp is an average value of a refractive index for d-line of one or more positive lenses included in the positive lens unit.

11. The zoom lens according to claim 1, wherein the following inequality is satisfied:
$$16 \text{.0} \leq vdPn \leq 30.$$
where vdPn is an average value of an Abbe number based on d-line of one or more negative lenses included in the positive lens unit.

12. The zoom lens according to claim 1, wherein the following inequality is satisfied:
$$1. 20 \leq β Pz / β Pw \times β Nz / β Nw \leq 1.6$$
where βNw is a lateral magnification of the second negative lens unit at the wide-angle end, βPz is a lateral magnification of the positive lens unit at a zoom position Za having a zoom magnification Z^{0.25} where Z is a zoom magnification from the wide-angle end to the telephoto end of the zoom lens, and βNz is a lateral magnification of the second negative lens unit at the zoom position Za.

13. The zoom lens according to claim 1, wherein the positive lens unit includes a positive lens disposed closest to an object, and
wherein the following inequality is satisfied:
$$0.90 \leq fPG 1 / fP \leq 1.8$$
where fPG1 is a focal length of the positive lens included in the positive lens unit, and fP is a focal length of the positive lens unit.

14. The zoom lens according to claim 1, wherein the first negative lens unit consists of three negative lenses and two positive lenses, and the second negative lens unit consists of one negative lens and one negative lens unit, and the positive lens unit consists of two positive lenses and one negative lens.

15. The zoom lens according to claim 1, wherein the first negative lens unit consists of a first partial lens unit and a second partial lens unit, the first partial lens unit consists of a single negative lens, the second partial lens unit consists of two negative lenses and two positive lenses, the second negative lens unit consists of two negative lenses and one positive lens, and the positive lens unit consists of two positive lenses and one negative lens.

16. An image pickup apparatus comprising:
a zoom lens; and
an image sensor configured to capture an object through the zoom lens,
wherein the zoom lens includes, in order from an object side to an image side:
a first lens unit having positive refractive power and fixed for zooming;
an intermediate group including three or more lens units that move for zooming;
a rear lens unit having positive refractive power and fixed for zooming,
wherein a distance between adjacent lens units changes during zooming,
wherein the intermediate group includes:
a first negative lens unit having negative refractive power as a whole and including a single lens unit or two or more partial lens units configured to monotonically move toward the image side during zooming from a wide-angle end to a telephoto end;
a positive lens unit having positive refractive power, disposed closest to an image plane, and configured to move during zooming; and
a second negative lens unit having negative refractive power, disposed on the object side of the positive lens, and configured to move during zooming, and
wherein the following inequalities are satisfied:
$$\begin{matrix}1. \leq f 1 / fR \leq 2.00 \\ - 5. \leq β P w \leq - 1.\end{matrix}$$
where f1 is a focal length of the first lens unit, fR is a focal length of the rear lens unit, and βPw is a lateral magnification of the positive lens unit at the wide-angle end.
